(19) United States
(12) Patent Application Publication
(10) Pub. No.: US 2026/0054183 A1
(43) Pub. Date: Feb. 26, 2026

(54) VIRTUAL EQUIPMENT RECOMMENDATION METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Cun XU, Shenzhen (CN); Qingyun ZHENG, Shenzhen (CN); Jie HU, Shenzhen (CN); Jin YU, Shenzhen (CN); Sirong XU, Shenzhen (CN); Huiqiang DUAN, Shenzhen (CN)

(21) Appl. No.: 19/372,792

(22) Filed: Oct. 29, 2025

Related U.S. Application Data
(63) Continuation of application No. PCT/CN2024/086302, filed on Apr. 7, 2024.

(30) Foreign Application Priority Data
Jun. 2, 2023 (CN) 202310651843.7

(51) Int. Cl. A63F 13/837; A63F 13/52; G06F 3/0482

(52) U.S. Cl. CPC A63F 13/837; A63F 13/52; G06F 3/0482; G06F 2203/04803

(57) ABSTRACT

A virtual equipment recommendation method includes: displaying a set recommendation interface in a shooting game, the set recommendation interface including a first area, and the first area including at least one set option; displaying, in response to a selection operation on a first set option of the at least one set option, recommended virtual equipment corresponding to the first set option in a second area of the set recommendation interface, appearances of the wearable equipment and the shooting equipment displayed in the second area having a skin style corresponding to the first set option; and displaying, in response to an acquisition operation on first virtual equipment of the recommended virtual equipment, an acquisition of the first virtual equipment and setting an appearance of the first virtual equipment according to the skin style.

### CROSS-REFERENCES TO RELATED APPLICATIONS

This application is a continuation of PCT Application No. PCT/CN2024/086302, filed on Apr. 7, 2024, which claims priority to Chinese Patent Application No. 202310651843.7, entitled “VIRTUAL EQUIPMENT RECOMMENDATION METHOD AND APPARATUS, DEVICE, AND STORAGE MEDIUM” filed on Jun. 2, 2023, the entire contents of all of which are incorporated herein by reference.

### FIELD OF THE TECHNOLOGY

The present disclosure relates to the field of application programs supporting virtual environments, and in particular, to a virtual equipment recommendation method and apparatus, a device, and a storage medium.

### BACKGROUND OF THE DISCLOSURE

In shooting games, a user can control a virtual character to operate virtual equipment, such as donning a virtual bulletproof vest or wielding a virtual pistol. Before using virtual equipment, the user needs to first acquire the virtual equipment for the virtual character. Moreover, to meet the user's personalized requirements, the game typically provides the user's virtual character with wearable equipment of various appearances and provides the functionality to set different skin styles to the shooting equipment. The user may acquire wearable equipment for the virtual character that matches their appearance preferences, and may acquire skins for the shooting equipment that align with their appearance preferences.

In shooting games with a high degree of realism, if the user's virtual character dies in the game, the user would lose the virtual equipment currently equipped on the virtual character. For example, if the virtual character is equipped with wearable equipment and shooting equipment, both the wearable equipment and the shooting equipment would be lost upon the virtual character's death. This requires the user to re-acquire the virtual equipment and set the corresponding skins, causing the user to frequently perform operations of acquiring virtual equipment and setting skins.

During the process of acquiring virtual equipment and setting skins for the virtual equipment, the user needs to browse through numerous pieces of wearable equipment of various categories and appearances, as well as skins of numerous pieces of shooting equipment and shooting equipment, and then set the skins of the shooting equipment after selection confirmation. When the above operations are performed frequently, the efficiency of configuring a complete set of skinned virtual equipment for the virtual character is relatively low.

### SUMMARY

The present disclosure provides a virtual equipment recommendation method and apparatus, a device, and a storage medium, which can enhance the efficiency of configuring a complete set of skinned virtual equipment for a virtual character. The technical solutions are described as follows:

According to an aspect of the present disclosure, there is provided a virtual equipment recommendation method, executed by a terminal, the method including: displaying a set recommendation interface in a shooting game, the set recommendation interface including a first area, and the first area including at least one set option; displaying, in response to a selection operation on a first set option of the at least one set option, recommended virtual equipment corresponding to the first set option in a second area of the set recommendation interface, the recommended virtual equipment including at least wearable equipment and shooting equipment, and appearances of the wearable equipment and the shooting equipment displayed in the second area having a skin style corresponding to the first set option; and displaying, in response to an acquisition operation on first virtual equipment of the recommended virtual equipment, an acquisition of the first virtual equipment and setting an appearance of the first virtual equipment according to the skin style, the first virtual equipment including at least one of the wearable equipment or the shooting equipment.

According to another aspect of the present disclosure, there is provided a virtual equipment recommendation apparatus, including: a display module, configured to display a set recommendation interface in a shooting game, the set recommendation interface including a first area, and the first area including at least one set option; the display module, further configured to display, in response to a selection operation on a first set option of the at least one set option, recommended virtual equipment corresponding to the first set option in a second area of the set recommendation interface, the recommended virtual equipment including at least wearable equipment and shooting equipment, and appearances of the wearable equipment and the shooting equipment displayed in the second area having a skin style corresponding to the first set option; and the display module, further configured to display, in response to an acquisition operation on first virtual equipment of the recommended virtual equipment, an acquisition of the first virtual equipment and set an appearance of the first virtual equipment according to the skin style, the first virtual equipment including at least one of the wearable equipment or the shooting equipment.

According to another aspect of the present disclosure, there is provided a computer device including a processor and a memory having at least one instruction, at least one program, a code set, or an instruction set stored therein, the at least one instruction, the at least one program, the code set, or the instruction set being loaded and executed by the processor to implement the virtual equipment recommendation method as described in the above aspect.

According to another aspect of the present disclosure, there is provided a non-transitory computer-readable storage medium having at least one instruction, at least one program, a code set, or an instruction set stored therein, the at least one instruction, the at least one program, the code set, or the instruction set being loaded and executed by a processor to implement the virtual equipment recommendation method as described in the above aspect.

The technical solutions provided by the present disclosure achieve at least the following advantageous effects:

By displaying a set recommendation interface and recommending a complete set of wearable equipment and shooting equipment according to the user's selection of a set option, the user can, by simply selecting a set option, obtain a system-recommended complete set of virtual equipment with a skin style corresponding to the set option. Moreover, when the user acquires the recommended virtual equipment, the system automatically sets the appearance of the virtual equipment according to the skin style selected by the user, without requiring any additional settings from the user. In cases that the user loses virtual equipment due to the virtual character's death and needs to frequently acquire virtual equipment and set the appearance of the virtual equipment, the efficiency of configuring a complete set of skinned virtual equipment for the virtual character can be enhanced.

### BRIEF DESCRIPTION OF THE DRAWINGS

FIG. 1 is a schematic structural diagram of a terminal according to an exemplary embodiment of the present disclosure.

FIG. 2 is a structural block diagram of a computer system according to an exemplary embodiment of the present disclosure.

FIG. 3 is a schematic diagram of a set recommendation interface according to an exemplary embodiment of the present disclosure.

FIG. 4 is a schematic diagram of recommended virtual equipment according to an exemplary embodiment of the present disclosure.

FIG. 5 is a schematic flow diagram of a virtual equipment recommendation method according to an exemplary embodiment of the present disclosure.

FIG. 6 is a schematic diagram of a loadout interface according to an exemplary embodiment of the present disclosure.

FIG. 7 is a schematic flow diagram of a virtual equipment recommendation method according to an exemplary embodiment of the present disclosure.

FIG. 8 is a schematic diagram of shooting equipment according to an exemplary embodiment of the present disclosure.

FIG. 9 is a schematic diagram of a virtual silencer without applied skins according to an exemplary embodiment of the present disclosure.

FIG. 10 is a schematic diagram of a virtual silencer with applied skins according to an exemplary embodiment of the present disclosure.

FIG. 11 is a schematic diagram of a second acquisition interface according to an exemplary embodiment of the present disclosure.

FIG. 12 is a schematic diagram of a sixth acquisition interface according to an exemplary embodiment of the present disclosure.

FIG. 13 is a schematic diagram of a loadout interface according to an exemplary embodiment of the present disclosure.

FIG. 14 is a schematic flow diagram of recommending and acquiring virtual equipment according to an exemplary embodiment of the present disclosure.

FIG. 15 is a schematic structural diagram of a virtual equipment recommendation apparatus according to an exemplary embodiment of the present disclosure.

FIG. 16 is a schematic structural diagram of a terminal according to an exemplary embodiment of the present disclosure.

### DESCRIPTION OF EMBODIMENTS

First, terms involved in embodiments of the present disclosure are introduced.

A virtual environment refers to a virtual environment displayed (or provided) when an application program is executed on a terminal. The virtual environment may be a simulated environment of the real world, a semi-simulated and semi-fictional environment, or a purely fictional environment. The virtual environment may be any one of a two-dimensional (2D) virtual environment, a 2.5-dimensional (2.5D) virtual environment, or a three-dimensional (3D) virtual environment, which is not limited to the embodiments of the present disclosure.

A virtual character refers to an active object in the virtual environment. The active object may be a virtual human, a virtual animal, an animated character, or the like, such as a character displayed in the 3D virtual environment. In some embodiments, the virtual character may be a 3D model created based on skeletal animation technology. Each virtual character has its own shape and volume in the 3D virtual world, occupying a portion of the space in the 3D virtual world.

Virtual equipment refers to equipment that can be used by a virtual character in a virtual environment. In shooting games, virtual equipment may be classified according to usage as wearable equipment, shooting equipment, consumable equipment, or the like. Wearable equipment refers to virtual equipment that functions when worn by a virtual character. Shooting equipment refers to virtual equipment used by a virtual character during shooting. Consumable equipment refers to virtual equipment that is consumed during shooting or otherwise used and consumed by the virtual character.

In some embodiments, the virtual equipment of the present disclosure is simulated based on real-world entities and possesses the same structure and characteristics as the corresponding real-world entities. For example, different main equipment and part equipment may be freely combined when compatible, thereby forming various virtual guns.

User interface (UT) control refers to any visible control or element on the UI of an application program, for example, controls such as pictures, input boxes, text boxes, buttons, and labels. Some of the UI controls respond to user operations.

First-person shooting (FPS) game refers to a shooting game in which a user can play from a first-person perspective, where the visuals of the virtual environment in the game are observed from the viewpoint of a virtual character controlled by the user. In the game, virtual characters from at least two factions engage in a single-match battle mode within the virtual environment. These virtual characters attempt to survive by avoiding attacks from other virtual characters and hazards present in the environment (such as poison zones and swamps). When a virtual character's health value in the virtual environment reaches zero, the life of the virtual character in the virtual environment ends. The virtual characters that remain alive in the virtual environment at the end are the winners. In some embodiments, the competitive mode of the battle (match) may include a single-player battle mode, a two-player team battle mode, or a multi-player team battle mode, which is not limited to the embodiments of the present disclosure.

The method provided in the present disclosure may be applied to an application program supporting a virtual environment. Exemplarily, the application program supporting a virtual environment is one in which a user can control the behavior of a virtual character within the virtual environment. Exemplarily, the method provided in the present disclosure can be applied to any of the following types of application programs: virtual reality (VR) application programs, augmented reality (AR) application programs, social application programs, interactive entertainment application programs, metaverse-related application programs, 3D map programs, VR games, AR games, shooting games (STG), FPS games, third-person shooting (TPS) games, fight technology games (FTG), action games (ACT), multiplayer online battle arena (MOBA) games, real-time strategy (RTS) games, massive/massively multiplayer online games (MMOG), arcade games, simulation games (SLG), and the like.

Exemplarily, the game in the virtual environment is composed of maps of one or more game worlds. The virtual environment in the game can simulate a real-world scene, and the user can control the virtual character in the game to carry out actions such as walking, running, jumping, shooting, combating, and driving in the virtual environment. The virtual vehicle can be controlled to travel in the virtual environment. The game is highly interactive, and a plurality of users can form teams online to engage in competitive games.

In some embodiments, the above application program may be a shooting game, speed racing game, role-playing game (RPG), adventure game, sandbox game, tactical battle game, or the like. The client may support at least one of the operating systems of Windows operating system, macOS, Android operating system, iOS operating system, and Linux operating system. Clients on different operating systems can interoperate and communicate with each other. In some embodiments, the above client is a program adapted to a mobile terminal with a touchscreen.

For example, the virtual equipment recommendation method provided in the embodiments of the present disclosure can be applied to an application program supporting a shooting game, in which a player can control a virtual character to use throwable items. For another example, the virtual equipment recommendation method provided in the embodiments of the present disclosure can be applied to an application program supporting an RPG, where the player can control a virtual character to use throwable items.

In some embodiments, the above client is an application program developed based on a 3D engine, for example, the 3D engine may be the Unity engine. The terminal in the present disclosure may be a desktop computer, a laptop computer, a mobile phone, a tablet computer, an e-book reader, a moving picture experts group audio layer III (MP3) player, a moving picture experts group audio layer IV (MP4) player, or the like. A client supporting the virtual environment, such as a client of an application program supporting a 3D virtual environment, is installed and run in the terminal. The application program may be any one of a battle royale (BR) game, a VR application program, an AR program, a 3D map program, a TPS game, an FPS game, a MOBA game, a racing game, or a speed racing game. In some embodiments, the application program may be a standalone application program, such as a standalone 3D game program, or a networked application program.

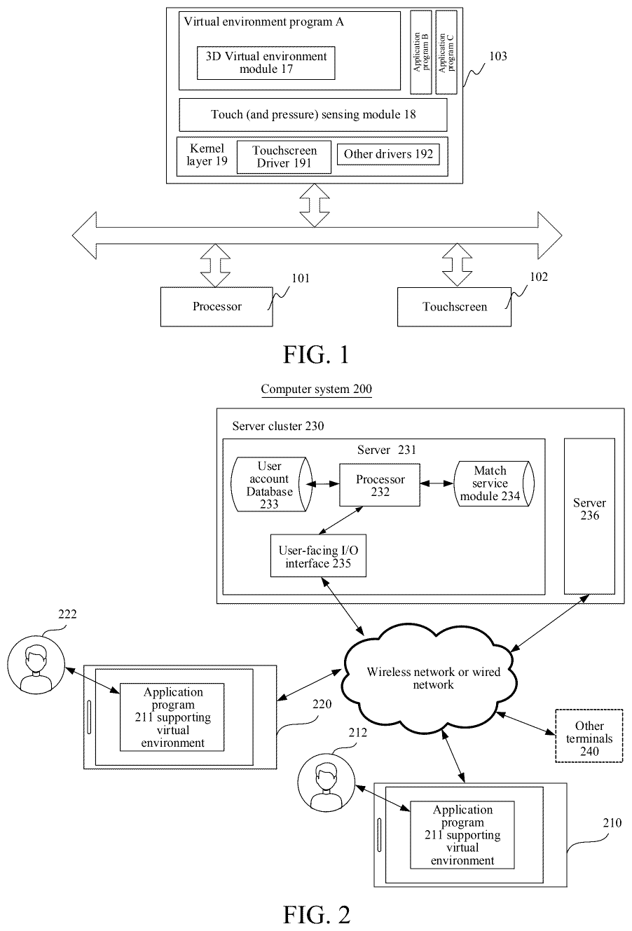

FIG. 1 is a schematic structural diagram of a terminal according to an exemplary embodiment of the present disclosure. The terminal includes a processor 101, a touchscreen 102, and a memory 103.

The processor 101 may be at least one of a single-core processor, a multi-core processor, an embedded chip, or a processor with instruction execution capability. The touchscreen 102 includes a general touchscreen or a pressure-sensitive touchscreen. The general touchscreen can detect press operations or scrolling operations applied to the touchscreen 102, while the pressure-sensitive touchscreen can measure the pressure level applied to the touchscreen 102.

The memory 103 stores a program executable by the processor 101. Exemplarily, the memory 103 stores a virtual environment program A, an application program B, an application program C, a touch (and pressure) sensing module 18, and a kernel layer 19 of an operating system. The virtual environment program A is an application program developed based on a 3D virtual environment module 17. In some embodiments, the virtual environment program A may include, but is not limited to, at least one of a game program, a VR program, a 3D map program, or a 3D presentation program developed by the 3D virtual environment module (also referred to as the virtual environment module) 17. For example, when the operating system of the terminal adopts the Android operating system, the virtual environment program A is developed using the Java programming language and C# language. For another example, when the operating system of the terminal adopts the iOS operating system, the virtual environment program A is developed using the Object-C programming language and the C# language.

The 3D virtual environment module 17 is a module supporting a plurality of operating system platforms. Exemplarily, the 3D virtual environment module may be configured for program development in a plurality of fields, such as game development fields, VR fields, and 3D map fields. The specific types of the 3D virtual environment module 17 are not limited to the embodiments of the present disclosure.

The touch (and pressure) sensing module 18 is a module configured to receive touch events (and pressure touch events) reported by the touchscreen driver 191. In some embodiments, the touch sensing module may not include a pressure sensing function and thus does not receive pressure touch events. The touch event includes a type and coordinate values of the touch event. The type of the touch event includes, but is not limited to, a touch start event, a touch move event, and a touch end event. The pressure touch events include a pressure value and coordinate values of the pressure touch event. The coordinate values are configured for indicating a touch position of a pressure touch operation on a display screen.

Exemplarily, the kernel layer 19 includes a touchscreen driver 191 and other drivers 192. The touchscreen driver 191 is a module configured to detect a pressure touch event. When the touchscreen driver 191 detects the pressure touch event, it transmits the pressure touch event to the touch (and pressure) sensing module 18.

The other drivers 192 may include drivers related to the processor 101, drivers related to the memory 103, drivers related to network assemblies, drivers related to sound assemblies, drivers related to acceleration measurement assemblies, or the like.

A person skilled in the art may know that the above is only a general exemplary description of the structure of the terminal. In different embodiments, the terminal may have more or fewer assemblies. For example, the terminal may further include an acceleration sensor, a gyroscope sensor, a power supply, and the like.

FIG. 2 is a structural block diagram of a computer system according to an exemplary embodiment of the present disclosure. The computer system 200 includes a first terminal 210, a second terminal 220, and a server cluster 230.

An application program 211 supporting the virtual environment is installed and run in the first terminal 210, and the application program 211 may be a client supporting the virtual environment. When the first terminal 210 runs the application program 211, a UI of the application program 211 is displayed on the screen of the first terminal 210. The application program 211 may be any one of an FPS game, a TPS game, a MOBA game, a competitive game, an SLG, a speed racing game, or a racing game. In this embodiment, the application program 211 is exemplified as an FPS game. The first terminal 210 is a terminal used by a first user 212, and the first user 212 uses the first terminal 210 to control the behavior of a first virtual character in the virtual environment.

An application program 221 supporting the virtual environment is installed and run in the second terminal 220, and the application program 221 may be a client supporting the virtual environment. When the second terminal 220 runs the application 221, a UI of the application program 221 is displayed on the screen of the second terminal 220. The application program 221 may be any one of an FPS game, a TPS game, a MOBA game, a competitive game, an SLG, a speed racing game, or a racing game. In some embodiments, the application program 221 may be identical to the application program 211, or the same application program under different operating systems, or a different version of the same application program. The second terminal 220 is a terminal used by a second user 222, and the second user 222 uses the second terminal 220 to control the behavior of a second virtual character in the virtual environment. In some embodiments, the second virtual character and the first virtual character may belong to the same faction or to different factions. When both belong to the same faction, at least one third virtual character exists in the virtual environment. The third virtual character is controlled by a third user via an application program on a third terminal and belongs to an opposing faction of the first virtual character.

The device types of the first terminal 210 and the second terminal 220 include at least one of a smartphone, tablet computer, e-book reader, MP3 player, MP4 player, laptop computer, and desktop computer.

Although only two terminals are shown in FIG. 2, in various embodiments, a plurality of other terminals 240 may exist. In some embodiments, at least one other terminal 240 may be a terminal corresponding to a developer. A development and editing platform for the client in the virtual environment is installed on the other terminal 240, enabling the developer to edit and update the client on the other terminal 240. The updated client installation package can then be transmitted to the server cluster 230 via a wired network or a wireless network, and the first terminal 210 and the second terminal 220 can download the client installation package from the server cluster 230 to update the client.

The first terminal 210, the second terminal 220, and the other terminals 240 are connected to the server cluster 230 via a wireless network or a wired network. The server cluster 230 includes at least one of a single server, a plurality of servers, a cloud computing platform, or a virtualization center. The server cluster 230 is configured to provide a background service for the client supporting the 3D virtual environment. In some embodiments, the server cluster 230 may perform primary computation while the terminals perform secondary computation; or the server cluster 230 may perform secondary computation while the terminals perform primary computation; or the server cluster 230 and the terminals may perform cooperative computation using a distributed computing architecture. In some embodiments, the terminals and the server described above are computer devices.

In a schematic example, the server cluster 230 includes a server 231 and a server 236. The server 231 includes a processor 232, a user account database 233, a match service module 234, and a user-facing input/output (I/O) interface 235. The processor 232 is configured to load instructions stored in the server 231 and process data in the user account database 233 and the match service module 234. The user account database 233 is configured to store data of user accounts used by the first terminal 210, the second terminal 220, and other terminals 240, such as the user account's avatar, nickname, owned virtual items, and service region. The match service module 234 is configured to provide services for matches involving virtual characters of different factions. The user-facing I/O interface 235 is configured to establish communication and exchange data with the first terminal 210 via a wireless network or a wired network. In combination with the above description of the virtual environment and the implementation environment, the following describes a virtual equipment recommendation method provided in the embodiments of the present disclosure.

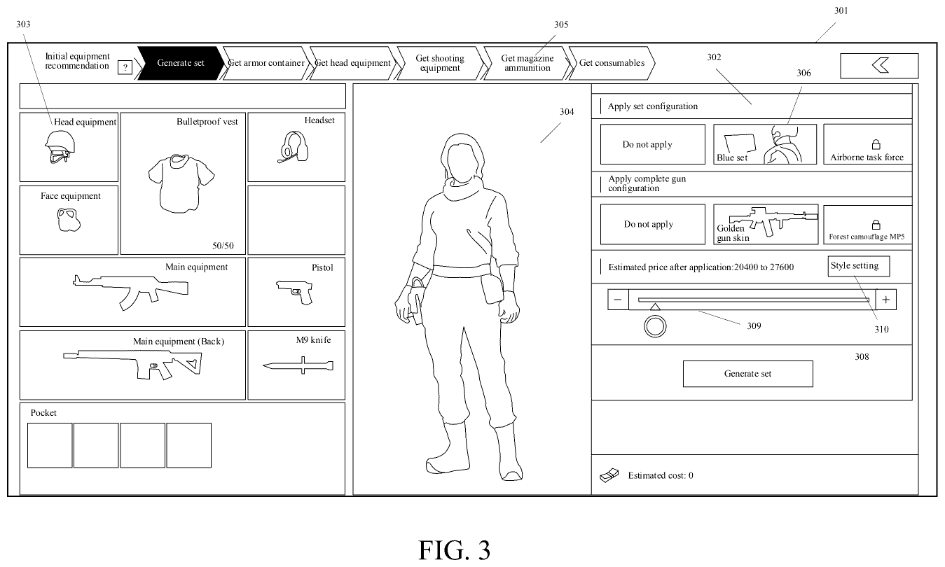

FIG. 3 is a schematic diagram of a set recommendation interface according to an exemplary embodiment of the present disclosure. As shown in FIG. 3, the client displays a set recommendation interface 301 for the shooting game. The set recommendation interface 301 includes a first area (set configuration selection area) 302, a second area (generate equipment preview area) 303, and a third area (visual preview area) 304. The first area 302 includes a first sub-area (apply set configuration) and a second sub-area (apply complete gun configuration). The first sub-area includes at least one first set option (e.g., a blue set), and the second sub-area includes at least one second set option (e.g., a golden gun skin).

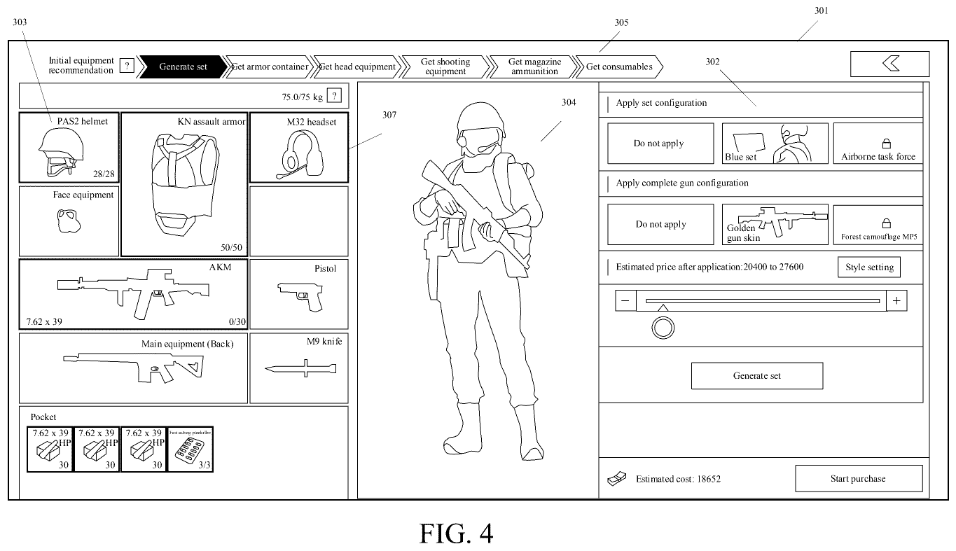

FIG. 4 is a schematic diagram of recommended virtual equipment according to an exemplary embodiment of the present disclosure. As shown in FIG. 3 and FIG. 4, in response to a selection operation on the first wearable set option and a selection operation on the first shooting set option, and upon triggering the generation of a set recommendation, the client may perform a recommendation of recommended virtual equipment. The client displays, in the second area 303, the wearable equipment corresponding to the first wearable set option and the shooting equipment corresponding to the first shooting set option. The appearance of the wearable equipment displayed in the second area 303 has a first skin style corresponding to the first wearable set option (e.g., the blue of the blue set), and the appearance of the shooting equipment displayed in the second area has a second skin style corresponding to the first shooting set option (e.g., the gold of the golden gun skin). In some embodiments, the wearable equipment includes at least one of body wearable equipment or head wearable equipment, and the shooting equipment includes at least one of main equipment or part equipment, where the main equipment and the part equipment are components of the shooting equipment. The recommended virtual equipment displayed in the second area 303 is a complete set of virtual equipment recommended to the user according to the user's selected set options. When recommending virtual equipment, the client displays preview information in the third area 304 to preview the visual in which the virtual character of the user account equips the above recommended virtual equipment.

Thereafter, the client sequentially displays acquisition interfaces for body wearable equipment, head wearable equipment, shooting equipment, consumable equipment of the shooting equipment, and consumable equipment of the virtual character, guiding the user to acquire each type of virtual equipment in order. In some embodiments, the acquisition interfaces may be equipment purchase interfaces. Exemplarily, with continued reference to FIG. 3 and FIG. 4, the set recommendation interface 301 includes an interface label control 305. When the current user interface is the set recommendation interface 301, the “generate set” label in the interface label control 305 is highlighted (e.g., using a different fill color, font color, and bold font). In the above user interfaces for acquiring different virtual equipment, the corresponding label in the interface label control 305 is highlighted. For example, in the user interface for acquiring body wearable equipment, the “acquire armor container” label is highlighted; in the user interface for acquiring head wearable equipment, the “acquire head equipment” label is highlighted; in the user interface for acquiring shooting equipment, the “acquire shooting equipment” label is highlighted; in the user interface for acquiring the first consumable equipment, the “acquire magazine ammunition” label is highlighted; and in the user interface for acquiring the second consumable equipment, the “acquire consumables” label is highlighted. Furthermore, in response to an acquisition operation of the recommended virtual equipment, the client may automatically equip the acquired virtual equipment on the virtual character, and, when the virtual equipment has a skin style indicated by the set option, set the appearance of the virtual equipment according to the skin style of the set option. In some embodiments, for the recommendation of virtual equipment, in addition to considering the user-selected recommended options, the equipment recommendation budget and equipment recommendation preferences set by the user are also considered. For example, if the preference is to acquire shooting equipment, more or higher-priced shooting equipment may be recommended within the set budget. Skin style, as used herein, may refer to a type of color, pattern, and/or texture of the corresponding equipment.

By displaying a set recommendation interface and recommending a complete set of wearable equipment and shooting equipment according to the user's selection of a set option, the user can, by simply selecting a set option, obtain a system-recommended complete set of virtual equipment with a skin style corresponding to the set option. The skin style corresponding to the set option may refer to that all equipment in the corresponding set have consistent (e.g., same or complimentary) appearances on at least one of color, pattern, or texture. Moreover, when the user acquires the recommended virtual equipment, the system automatically sets the appearance of the virtual equipment according to the skin style selected by the user, without requiring any additional settings from the user. In cases that the user loses virtual equipment due to the virtual character's death and needs to frequently acquire virtual equipment and set the appearance of the virtual equipment, the efficiency of configuring a complete set of skinned virtual equipment for the virtual character can be enhanced.

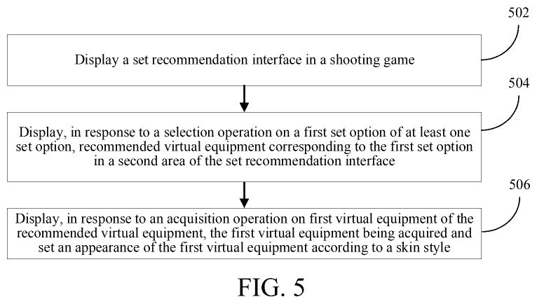

FIG. 5 is a schematic flow diagram of a virtual equipment recommendation method according to an exemplary embodiment of the present disclosure. The method can be applied to a terminal or to a client within a terminal in the system shown in FIG. 2. As shown in FIG. 5, the method includes:

Operation 502: Display a set recommendation interface in a shooting game.

The shooting game includes a TPS game and an FPS game, and further includes other games that allow the current user account to control a virtual character to perform shooting actions within the virtual environment. The current user account refers to the user account of the user currently logged into the client.

The above virtual environment may be a simulated environment of the real world, a semi-simulated and semi-fictional environment, or a purely fictional environment. In some embodiments, in an FPS game, the virtual environment displayed by the client is presented from the first-person perspective corresponding to the virtual character controlled by the current user account, thereby observing and displaying the complete virtual environment. In some embodiments, in a TPS game, the virtual environment displayed by the client is presented from the third-person perspective corresponding to the virtual character controlled by the current user account, thereby observing and displaying the complete virtual environment, where the above perspective changes according to the control operations performed by the current user account on the virtual character. The above virtual character refers to an active object in the virtual environment. The active object may be a virtual human, a virtual animal, an animated character, or the like, such as a character displayed in the 3D virtual environment.

The set recommendation interface refers to the current user account interface in the shooting game's client, configured for recommending a complete set of virtual equipment to the current user account. Virtual equipment refers to equipment that can be used by a virtual character in a virtual environment. In shooting games, virtual equipment may be classified according to usage as wearable equipment, shooting equipment, consumable equipment, or the like. Wearable equipment refers to virtual equipment that functions when worn by a virtual character. Shooting equipment refers to virtual equipment used by a virtual character during shooting. Consumable equipment refers to virtual equipment that is consumed during shooting or otherwise used and consumed by the virtual character. In some embodiments, when the current user account organizes its owned virtual equipment, the client displays a loadout interface for preparing the virtual equipment, the loadout interface including a set recommendation control. In response to a trigger operation on the set recommendation control, the client displays the set recommendation interface. In some embodiments, the trigger operation includes touch operations, such as single tap, double tap, or multi-tap, detected via a display screen, mouse, keyboard, or other external devices.

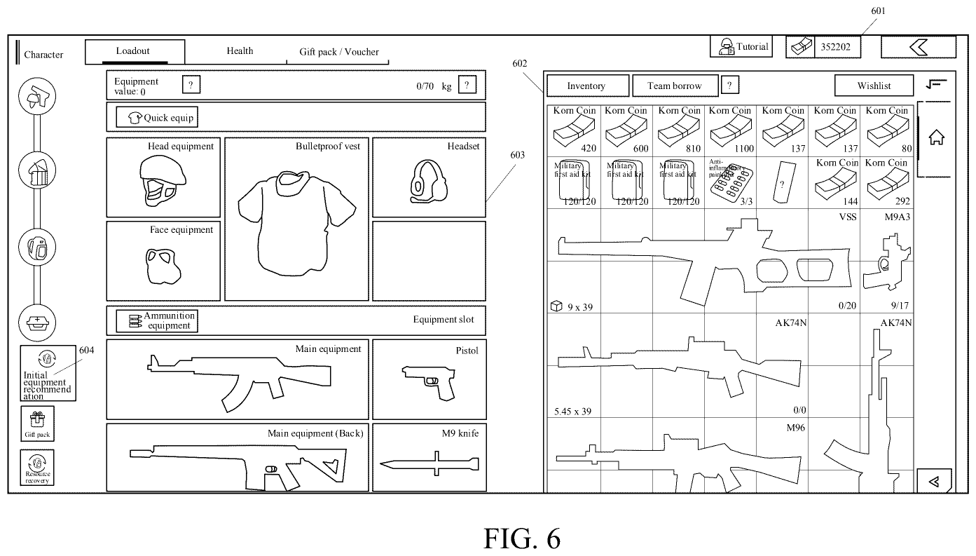

Exemplarily, FIG. 6 is a schematic diagram of a loadout interface according to an exemplary embodiment of the present disclosure. As shown in FIG. 6, in the loadout interface 601, an inventory area 602 is displayed, and the virtual equipment owned by the current user account is displayed in the inventory area 602. The loadout interface 601 further includes an equipment area 603, and virtual equipment that has been equipped by the current user account for the virtual character is displayed in the equipment area 603. The loadout interface 601 includes a set recommendation control (initial equipment recommendation) 604, and the client displays the set recommendation interface in response to a single-tap operation on the set recommendation control 604. The set recommendation interface can be referred to as examples in FIG. 3 and FIG. 4. The set recommendation interface includes a first area, which includes at least one set option. The first area is the display area in the set recommendation interface, and the set options are displayed in the form of controls, such as the rectangular control 306 in FIG. 3 and FIG. 4. The set option displays information configured for reflecting the skin style corresponding to the set option, and the skin style may affect the appearance of the virtual equipment corresponding to the set option. For example, the rectangular control 306 in FIG. 3 and FIG. 4 displays “blue set,” indicating that the set option has a blue skin style.

Operation 504: Display, in response to a selection operation on a first set option of the at least one set option, recommended virtual equipment corresponding to the first set option in a second area of the set recommendation interface.

The first set option is the set option selected through a selection operation from the at least one set option provided in the set recommendation interface. In some embodiments, the selection operation includes touch operations, such as single tap, double tap, or multi-tap, detected via a display screen, mouse, keyboard, or other external devices.

The recommended virtual equipment includes at least wearable equipment and shooting equipment. In some embodiments, the recommended virtual equipment further includes other virtual equipment, such as consumable equipment. The consumable equipment includes first consumable equipment consumed when using the shooting equipment and second consumable equipment used by the virtual character of the current user account. The first consumable equipment is matched with the shooting equipment, and the second consumable equipment may be consumable equipment that is either not owned by the current user account or owned but in a quantity below a threshold. For example, the shooting equipment is a virtual rifle, and the first consumable equipment includes a magazine and bullets, both matching the model of the virtual rifle. The second consumable equipment includes a virtual medical kit, virtual painkillers, virtual energy supplements, virtual food, virtual grenades, virtual smoke grenades, virtual flashbangs, virtual Molotov cocktails, and the like, which can provide buff effects for the virtual character and/or be used during combat by the virtual character.

When the client displays the recommended virtual equipment in the second area, the recommended virtual equipment is classified and displayed according to the types of recommended virtual equipment. Exemplarily, with continued reference to FIG. 4, the second area 303 includes a plurality of equipment slots 307, with each recommended virtual equipment displayed in one of the equipment slots 307 in the second area. In addition, in a case that there is a large number of recommended virtual equipment and the second area 303 cannot fully display them, in response to a scrolling operation in the second area 303, the client scrolls the display content within the second area 303 to ensure that all recommended virtual equipment can be displayed.

In some embodiments, the wearable equipment includes head wearable equipment worn on the virtual character's head, such as virtual helmets, virtual masks, and virtual headsets, which can provide protective effects to the virtual character. The wearable equipment further includes body wearable equipment worn on the virtual character's body, such as virtual clothes, virtual armor, virtual plate armor, virtual chest armors, virtual containers (e.g., virtual backpacks, virtual pouches, and virtual holsters), and virtual ammunition pouches (for holding magazines), which can provide protective effects for the virtual character and accommodate other virtual equipment. The shooting equipment includes virtual pistols, rifles, sniper rifles, submachine guns, machine guns, and the like, and may further include daggers, knives, swords, axes, etc., which are thrown to achieve “shooting effects”. The shooting equipment includes main equipment and part equipment. For example, a virtual rifle includes the rifle body and parts (accessories) such as the magazine, stock, scope, and suppressor, which are installed on the rifle body. These parts can provide some attribute bonuses to the shooting equipment. The consumable equipment used during shooting can include virtual bullets of various specifications, while the equipment consumed by virtual characters can include virtual medical kits, virtual first aid kits, virtual energy supplements, virtual painkillers, and the like, which can provide bonus effects for the virtual characters.

The appearances of the wearable equipment and shooting equipment displayed in the second area have a skin style corresponding to the first set option. For example, the wearable equipment and shooting equipment displayed in the second area are obtained by applying the skin style to the wearable equipment and shooting equipment. Virtual equipment (e.g., wearable equipment and shooting equipment) has a default appearance. For example, the virtual bulletproof vest appears green in the default appearance, and a virtual rifle appears black in the default appearance. The skin style may affect the appearance style of the virtual equipment, such as the color of the virtual equipment. In some examples, the skin style may affect the performance of the virtual equipment. For example, a virtual bulletproof vest with a camouflage skin style offers better blocking effects against virtual attacks compared to a virtual bulletproof vest with the default green appearance. In other examples, the skin style provides additional bonus effects, for example, a virtual rifle with a gold skin style offers extra virtual gold coin earnings. In some embodiments, the client applies the skin to the wearable equipment and shooting equipment in the default appearance according to the skin color and shading mode corresponding to the skin style, thereby obtaining the wearable equipment and shooting equipment displayed in the second area. For example, the skinning process involves applying the skin colors to the surface of the virtual equipment according to the shading mode. The shading mode is configured for indicating the placement of different skin colors on the surface of the virtual equipment. For example, the shading mode indicates applying a golden color to the barrel surface of the virtual rifle, while other areas of the surface are not skinned. Exemplarily, the client applies a camouflage skin to the virtual bulletproof vest according to a camouflage style, and applies a golden skin to the virtual rifle according to a gold style. The above selection is made for the first set option, i.e., for the skin style of the appearance of the recommended virtual equipment.

In some embodiments, in the process of determining the recommended virtual equipment, the recommended virtual equipment is further determined according to the equipment recommendation budget set by the current user account in the set recommendation interface, and/or according to the equipment recommendation preferences set by the current user account in the set recommendation interface. For example, if the preference is to acquire shooting equipment, more or higher-priced shooting equipment may be recommended within the equipment recommendation budget. The process of determining the recommended virtual equipment is completed either independently by the client, by the server, or through cooperation between the client and the server. In some embodiments, the set options include at least one first set option and at least one second set option. The first set option may affect the appearance of the wearable equipment (also referred to as the wearable set option), and the second set option may affect the appearance of the shooting equipment (also referred to as the shooting set option).

Operation 506: Display, in response to an acquisition operation on first virtual equipment of the recommended virtual equipment, an acquisition of the first virtual equipment and set an appearance of the first virtual equipment according to the skin style. Displaying an acquisition of certain equipment, as used herein, may refer to displaying the equipment on the interface in a manner indicating that the equipment is acquired. For example, the acquired equipment can be displayed as being equipped on a virtual character and/or being placed in an inventory of the virtual character. In some embodiments, the acquisition operation of equipment may refer to an in-game purchase action of the equipment.

The first virtual equipment is the virtual equipment selected for acquisition from a plurality of recommended virtual equipment during the acquisition operation operation. In some embodiments, the client provides the function to acquire (e.g., purchase) all recommended virtual equipment in the set recommendation interface. Alternatively, the client sequentially displays acquisition interfaces for different types of virtual equipment according to the types of a plurality of recommended virtual equipment, and provides the function to acquire the corresponding virtual equipment in the acquisition interface. For example, the acquisition interfaces for body wearable equipment, head wearable equipment, shooting equipment, consumable equipment for shooting equipment, and consumable equipment for virtual characters are displayed sequentially, allowing the current user account to acquire different types of virtual equipment in sequence, thereby ensuring the integrity of the acquired virtual equipment.

The first virtual equipment includes at least one of the wearable equipment or the shooting equipment. That is, when the current user account acquires (e.g., purchases) the wearable equipment and shooting equipment corresponding to the set option, the client automatically sets the appearance of the first virtual equipment according to the skin style corresponding to the set option, i.e., sets the skin style to the first virtual equipment. In some embodiments, when acquiring the first virtual equipment, the client first acquires the first virtual equipment with the default appearance for the current user account, and then automatically applies the skin to the first virtual equipment according to the skin style. In some embodiments, each virtual equipment included in the wearable equipment and shooting equipment either fully supports setting the appearance according to the skin style of the set option, or partially supports setting the appearance according to the skin style of the set option. When it supports setting the appearance according to the skin style of the set option, the appearance may be set according to the skin style of the set option when displayed in the second area and when acquired.

In some embodiments, for other virtual equipment in the recommended virtual equipment, there is no concept of setting an appearance (skin). Alternatively, for other virtual equipment in the recommended virtual equipment, such as consumable equipment, the appearance can be set according to the skin style of the set option. When such consumable equipment is displayed, the appearance may be set according to the skin style of the set option, and the appearance may be automatically set according to the skin style of the set option during acquisition.

In summary, according to the method provided in this embodiment, by displaying a set recommendation interface and recommending a complete set of wearable equipment and shooting equipment according to the user's selection of a set option, the user can, by simply selecting a set option, obtain a system-recommended complete set of virtual equipment with a skin style corresponding to the set option. Moreover, when the user acquires the recommended virtual equipment, the system automatically sets the appearance of the virtual equipment according to the skin style selected by the user, without requiring any additional settings from the user. In cases that the user loses virtual equipment due to the virtual character's death and needs to frequently purchase virtual equipment and set the appearance of the virtual equipment, the efficiency of configuring a complete set of skinned virtual equipment for the virtual character can be enhanced.

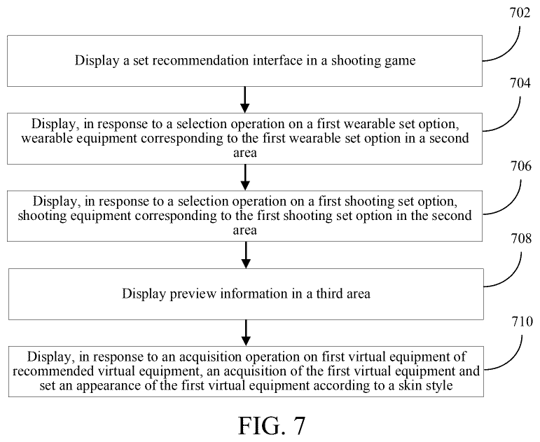

FIG. 7 is a schematic flow diagram of a virtual equipment recommendation method according to an exemplary embodiment of the present disclosure. The method can be applied to a terminal or to a client within a terminal in the system shown in FIG. 2. As shown in FIG. 7, the method includes:

Operation 702: Display a set recommendation interface in a shooting game.

The set recommendation interface refers to the current user account interface in the shooting game's client, configured for recommending a complete set of virtual equipment to the current user account. The shooting game includes a TPS game and an FPS game, and further includes other games that allow the current user account to control a virtual character to perform shooting actions within the virtual environment.

The set recommendation interface includes a first area. The first area includes a first sub-area and a second sub-area, the first sub-area including at least one wearable set option, and the second sub-area including at least one shooting set option. Exemplarily, with continued reference to FIG. 3 and FIG. 4, the first sub-area is an area corresponding to the “apply set configuration”, and the second sub-area is an area corresponding to the “apply complete gun configuration”. The set options are displayed in the form of controls, such as the rectangular control. The wearable set option displays information configured for reflecting a first skin style corresponding to the wearable set option, and the first skin style may determine the appearance of the wearable equipment corresponding to the wearable set option. The shooting set option displays information configured for reflecting the second skin style corresponding to the shooting set option, and the second skin style may determine the appearance of the shooting equipment corresponding to the shooting set option.

In some embodiments, the client determines the skin style corresponding to the set option, according to the skin style of the appearance of the wearable equipment and shooting equipment of the relevant user account of the current user account. The relevant user account includes at least one of a friend user account of the current user account, a user account frequently teamed with the current user account, a lover user account of the current user account, or a user account followed by the current user account. The client determines a skin style that is similar to, identical to, or matches the skin style of the appearance of the wearable equipment and/or shooting equipment of the relevant user account, and determines the skin style corresponding to the set option according to the skin style. For example, the client determines the skin style of the wearable equipment currently equipped by the virtual character of the lover user account of the current user account as the first skin style corresponding to a wearable set option, and determines the skin style of the shooting equipment currently equipped by the virtual character of the lover user account of the current user account as the second skin style corresponding to a shooting set option.

Operation 704: Display, in response to a selection operation on a first wearable set option, wearable equipment corresponding to the first wearable set option in a second area.

The first wearable set option is a set option selected through the selection operation from at least one wearable set option. Exemplarily, as shown in FIG. 4, the first area includes a sub-area (referred to as the first sub-area), which provides at least one wearable set to be selected. The wearable set is a skin configuration for the virtual character's clothing. The selection operation of the first wearable set option is achieved by performing a human-machine interaction operation in the first sub-area of the first area.

Accordingly, the wearable equipment corresponding to the first wearable set option displayed in the second area is the wearable equipment recommended to the current user account according to the first wearable set option. The appearance of the wearable equipment displayed in the second area has a first skin style corresponding to the first wearable set option, and the wearable equipment displayed in the second area can be considered as having the skin corresponding to the first wearable set option. The first skin style may affect the appearance style of the wearable equipment, such as the color of the wearable equipment. The selection is made for the first wearable set option, i.e., for the skin style of the appearance of the recommended wearable equipment.

In some embodiments, the wearable equipment includes at least one of the head wearable equipment worn on the virtual character's head or the body wearable equipment worn on the virtual character's body. The client displays at least one of the body wearable equipment or the head wearable equipment corresponding to the first wearable set option in the second area. The appearance of all or part of the virtual equipment corresponding to the first wearable set option displayed in the second area has a first skin style. For example, a virtual armor, a virtual helmet, and a virtual mask are displayed in the second area, but only the appearance of the virtual armor and the virtual helmet is set according to the first skin style.

In some embodiments, when the client receives the selection operation for the first wearable set option and a generate set operation, the wearable equipment corresponding to the first wearable set option is displayed in the second area. In some embodiments, the set recommendation interface further includes a generate control, and the generate set operation is triggered by a touch on the generate control. Exemplarily, with continued reference to FIG. 3 and FIG. 4, when the client receives a selection operation for the “blue set” and then receives a touch operation on the generate control 308 for “generate set”, the client may trigger the recommendation of wearable equipment according to the set option of “blue set”.

In an embodiment, after operation 704, the method further includes: visually highlighting, in response to the selection operation on the first wearable set option, a recommended shooting set option of the at least one shooting set option.

The recommended shooting set option is one of the shooting set options in at least one of the shooting set options displayed in the second sub-area. Exemplarily, the methods of visually highlighting the recommended shooting set option include, but are not limited to, at least one of the following: highlighting the recommended shooting set option, bolding the outer contours of the recommended shooting set option, making the recommended shooting set option blink, or displaying the recommended shooting set option with the same horizontal coordinate/vertical coordinate as the first wearable set option.

Exemplarily, the recommended shooting set option is determined according to the selection operation corresponding to the first wearable set option. Exemplarily, recommended shooting equipment corresponding to the recommended shooting set option shares at least one of a texture, material, or bonus effect with the wearable equipment corresponding to the first wearable set option. In one example, the recommended shooting equipment and wearable equipment have the same texture, such as at least one of the patterns, fill colors, grooves, or protrusions being the same. The recommended shooting equipment and wearable equipment are visually similar, which facilitates the quick unification of the skin style of the virtual character's assembled equipment. In another example, the recommended shooting equipment and wearable equipment have the same material, such as the recommended shooting equipment and wearable equipment being made of metal with a metallic sheen, or being made of wood with a soft, non-reflective appearance. The recommended shooting equipment and wearable equipment have similar gloss, which facilitates the quick unification of the virtual character's assembled equipment for a reflective gloss effect. In yet another example, the recommended shooting equipment and wearable equipment have the same bonus effects, such as increasing the virtual attack speed and virtual attack range, which facilitates the quick selection of equipment with the same bonus effects, enabling the rapid stacking of the same bonus effect through the assembly of the virtual character's equipment.

Operation 706: Display, in response to a selection operation on a first shooting set option, shooting equipment corresponding to the first shooting set option in the second area.

The first shooting set option is the set option selected through the selection operation from at least one shooting set option. Exemplarily, as shown in FIG. 4, the first area includes another sub-area (referred to as the second sub-area), which provides at least one shooting set to be selected. The shooting set is a skin configuration for the virtual shooting items equipped by the virtual character. The selection operation of the first shooting set option is achieved by performing a human-machine interaction operation in the first sub-area of the first area.

Accordingly, the shooting equipment corresponding to the first shooting set option displayed in the second area is the shooting equipment recommended to the current user account according to the first shooting set option. The appearance of the shooting equipment displayed in the second area has a second skin style corresponding to the first shooting set option, and the shooting equipment displayed in the second area can be considered as having the skin corresponding to the first shooting set option. The second skin style may affect the appearance style of the shooting equipment, such as the color of the shooting equipment. The selection is made for the first shooting set option, i.e., for the skin style of the appearance of the recommended shooting equipment.

In some embodiments, the shooting equipment in the shooting game includes main equipment and part equipment. The client displays at least one of the main equipment or the part equipment corresponding to the first shooting set option in the second area. In some embodiments, when the first shooting set option corresponds to the main equipment and the part equipment, the shooting equipment displayed in the second area is obtained by assembling the main equipment and the part equipment. The main equipment and part equipment corresponding to the first shooting set option are matched with each other, for example, the main equipment is a virtual rifle body, and the part equipment is a virtual silencer and a virtual stock, with the model of the part equipment being compatible with the main equipment. The appearance of all or part of the virtual equipment corresponding to the first shooting set option displayed in the second area has a second skin style. For example, the second area displays a virtual rifle body, a virtual silencer, and a virtual stock, but only the appearance of the virtual rifle body and the virtual silencer is set according to the second skin style.

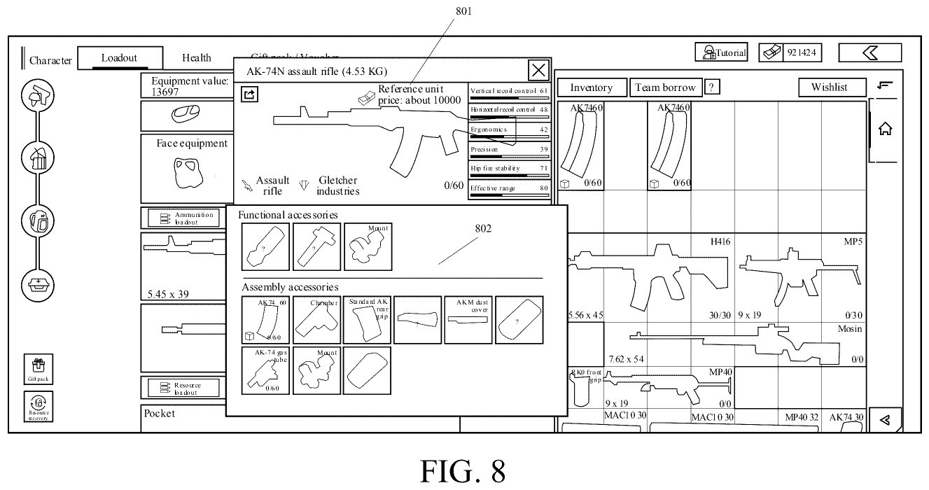

Exemplarily, FIG. 8 is a schematic diagram of shooting equipment according to an exemplary embodiment of the present disclosure. As shown in FIG. 8, the shooting equipment is a virtual rifle 801. The virtual rifle 801 includes a rifle body and rifle parts 802. The rifle parts 802 include functional accessories and assembly accessories. The functional accessories include a virtual silencer, a virtual grip, and a virtual scope, while the assembly accessories include a virtual magazine, a virtual chamber, a virtual rear grip, a virtual stock, a virtual dust cover, and the like.

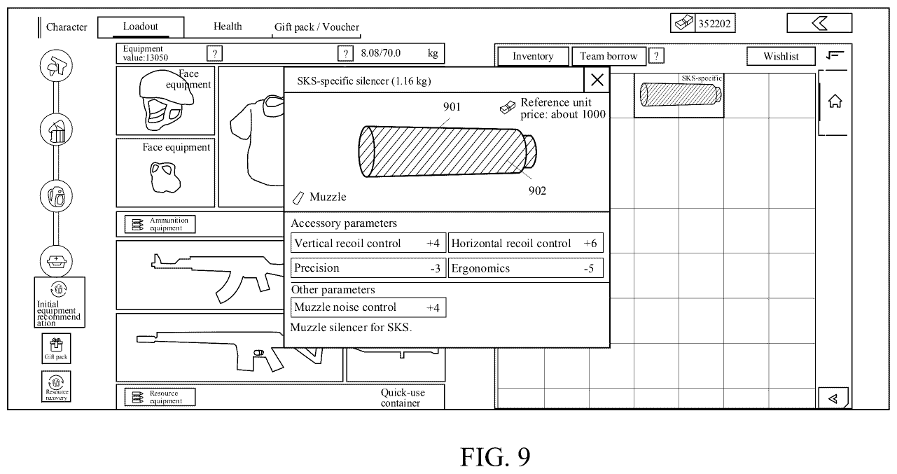

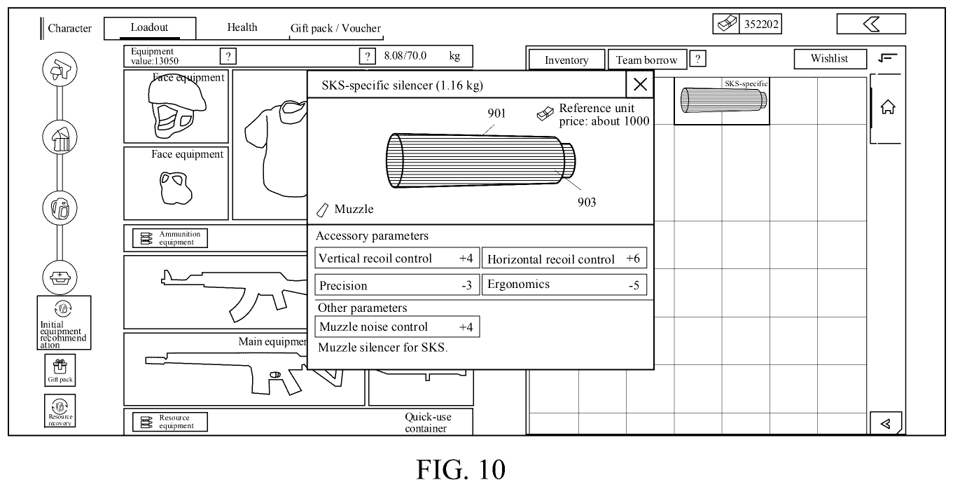

Exemplarily, FIG. 9 is a schematic diagram of a virtual silencer without applied skins according to an exemplary embodiment of the present disclosure. FIG. 10 is a schematic diagram of a virtual silencer with applied skins according to an exemplary embodiment of the present disclosure. As shown in FIG. 9, the virtual silencer 901, when no skin is applied, has a color of the first color 902, such as black. As shown in FIG. 10, the virtual silencer 901, when a skin is applied, has a color of the second color 903, such as golden yellow.

In some embodiments, when the client receives the selection operation for the first shooting set option and the generate set operation, the shooting equipment corresponding to the first shooting set option is displayed in the second area. Exemplarily, with continued reference to FIG. 3 and FIG. 4, when the client receives a selection operation for the “golden gun skin” and then receives a touch operation on the generate control 308 for “generate set”, the client may trigger the recommendation of shooting equipment according to the set option of “golden gun skin”.

When selecting the wearable set option and the shooting set option, either both can be selected or one can be chosen, and then the generate set operation is triggered. In this case, the client may recommend virtual equipment according to the selected set options. For example, if only the wearable set option is selected, shooting equipment with skin may not be recommended; if only the shooting set option is selected, wearable equipment with skin may not be recommended. In addition, when recommending virtual equipment to the current user account according to the wearable set option and/or the shooting set option selected by the current user account, the client may recommend other virtual equipment in addition to the wearable equipment and shooting equipment. For example, in a case of recommending shooting equipment, the client may recommend the first consumable equipment that matches the shooting equipment. In addition, the client may recommend the second consumable equipment used by the virtual character of the current user account.

The process of determining the recommended virtual equipment for the current user account is as follows:

The set recommendation interface further includes a budget setting control. In response to the budget setting operation on the budget setting control, the client acquires the equipment recommendation budget. Exemplarily, with continued reference to FIG. 3 and FIG. 4, the set recommendation interface 301 includes a budget setting control 309. The budget setting control 309 includes a slider and an indicator. By moving the indicator along the slider, the equipment recommendation budget can be adjusted. In some embodiments, the equipment recommendation budget is a range. When recommending virtual equipment according to the set options selected by the current user account, the client may recommend virtual equipment within the equipment recommendation budget. That is, the recommended virtual equipment displayed in the second area is recommended based on the equipment recommendation budget. The total price of all recommended virtual equipment does not exceed the equipment recommendation budget. In some embodiments, the client may randomly select wearable equipment, shooting equipment, and consumable equipment that meet the set options from the virtual equipment to be recommended that satisfies the price budget, as the recommended virtual equipment for the current user account. Exemplarily, when recommending virtual equipment according to the equipment recommendation budget, the client adopts a strategy that aims to recommend as many types of virtual equipment as possible for virtual equipment recommendation, to ensure that the user can acquire a complete set of virtual equipment. For example, when recommending virtual equipment according to the minimum equipment recommendation budget, the client may adopt a strategy that recommends the maximum number of types of virtual equipment, while ensuring that the price of each type of virtual equipment is the lowest. When recommending virtual equipment according to the maximum equipment recommendation budget, the client may adopt a strategy that recommends the maximum number of types of virtual equipment, while ensuring that the price of each type of virtual equipment is the highest.

The set recommendation interface further includes a recommendation preference setting control. In response to the recommendation preference setting operation on the recommendation preference setting control, the client acquires the equipment recommendation preference information (recommendation style). Exemplarily, with continued reference to FIG. 3 and FIG. 4, the set recommendation interface 301 includes a recommendation preference setting control 310. Through the recommendation preference setting control 310, the current user account can select the equipment recommendation preference information that meets the needs. In some embodiments, the equipment recommendation preference information includes at least one of the preferences for defensive equipment, offensive equipment, high-priced equipment, or low-priced equipment. In a case of a preference for defensive equipment, when the client determines the recommended virtual equipment, the quantity or price of the defensive equipment determined may be higher than that of the offensive equipment. In a case of a preference for offensive equipment, when the client determines the recommended virtual equipment, the quantity or price of the offensive equipment determined may be higher than that of the defensive equipment. In a case of a preference for high-priced equipment, when determining the recommended virtual equipment, the client may recommend virtual equipment from the candidate virtual equipment that is priced higher than the first price threshold, or determine the recommended virtual equipment from the top a priced virtual equipment. In a case of a preference for low-priced equipment, when determining the recommended virtual equipment, the client may recommend virtual equipment from the candidate virtual equipment that is priced lower than the second price threshold, or determine the recommended virtual equipment from the bottom b priced virtual equipment. The first price threshold is higher than the second price threshold, and a and b are positive integers. In some embodiments, the solution for recommending virtual equipment according to the equipment recommendation preference information and the solution for recommending virtual equipment according to the selected set options are parallel solutions. For example, when no set options are selected, the recommendation preference setting control may be displayed normally, indicating it can be tapped. When a set option is selected, the recommendation preference setting control may be displayed in gray, indicating it cannot be tapped. In some embodiments, the solutions for recommending virtual equipment according to recommendation preference information and recommending virtual equipment according to the equipment recommendation budget can be applied simultaneously, that is, while recommending virtual equipment according to recommendation preference information, the total price of the recommended virtual equipment may be considered to ensure it does not exceed the equipment recommendation budget.

The client acquires appearance setting habits of frequently used main equipment and frequently used part equipment of the current user account. The frequently used main equipment is the main equipment used by the virtual character of the current user account, with a usage frequency greater than the first frequency threshold or a usage count greater than the first count threshold within a historical period. The frequently used part equipment is the part equipment used by the virtual character of the current user account, with a usage frequency greater than the second frequency threshold or a usage count greater than the second count threshold within a historical period. Appearance setting habits are configured for reflecting the equipment with appearance settings (e.g., the appearance of the equipment is set to show a certain skin style, comparing to other equipment with a default skin style or no skin style setting) in the frequently used main equipment and frequently used part equipment. When recommending virtual equipment, the client may set, based on the skin style and according to the appearance setting habits, appearances of the main equipment and part equipment of the shooting equipment in the recommended virtual equipment determined, to obtain the shooting equipment displayed in the second area. For example, the frequently used virtual rifle body is set to appear in a skin style, and in the frequently used part equipment, only the virtual silencer is applied with a user-identified skin. When recommending a virtual sniper rifle to the current user account, the client may apply skins to the virtual sniper rifle body and the silencer.

When determining the recommended virtual equipment, the client acquires, from the current user account's frequently used part equipment, the matching part equipment that supports appearance settings according to the selected skin style, then determines a plurality pieces of main equipment that match the matching part equipment, and determines, from the plurality pieces of main equipment, the matching main equipment that supports appearance settings according to the selected skin style. Then, according to the matching part equipment and the matching main equipment, the shooting equipment in the recommended virtual equipment is generated. For example, when recommending shooting equipment according to the selected golden gun skin, the client acquires, from the current user account's frequently used part equipment, the frequently used virtual silencer that supports the golden gun skin setting. Then, from the candidate main equipment, the client determines the main equipment matching the virtual silencer (i.e., main equipment that supports the installation of the virtual silencer), and selects from these the main equipment that supports the golden gun skin setting. Finally, the main equipment is combined with the virtual silencer to be recommended as the shooting equipment to the current user account.

When determining the recommended virtual equipment, the client acquires at least one leaderboard of a first leaderboard, a second leaderboard, a third leaderboard, a fourth leaderboard, and a fifth leaderboard. According to the main equipment and part equipment of the top n shooting equipment in the at least one leaderboard, the client generates the shooting equipment in the recommended virtual equipment. In a case that the top n shooting equipment in the at least one leaderboard includes a plurality pieces of shooting equipment, the client recommends the same shooting equipment according to a piece of shooting equipment. Alternatively, according to all the main equipment and part equipment of the plurality pieces of shooting equipment, the client selects one piece of main equipment and one or more pieces of part equipment to form the recommended shooting equipment. The first leaderboard is configured to rank different shooting equipment according to shooting accuracy, the second leaderboard is configured to rank the different shooting equipment according to shooting damage, the third leaderboard is configured to rank the different shooting equipment according to the number of uses, the fourth leaderboard is configured to rank the different shooting equipment according to win rate, and the fifth leaderboard is configured to rank the different shooting equipment according to points of corresponding user accounts. The different shooting equipment includes at least one of shooting equipment of friend user accounts, shooting equipment of same-team user accounts, or shooting equipment of same-server user accounts of the current user account, and n is a positive integer. For example, the client acquires the top 3 shooting equipment with the highest shooting accuracy from all user accounts on the server, and according to all the main equipment and part equipment included in these 3 pieces of shooting equipment, selects one piece of main equipment and one piece of part equipment to form the recommended design equipment for the current user account.

The above solution for determining the recommended virtual equipment for the current user account can be implemented independently or in combination.

Operation 708: Display preview information in the third area.

The preview information includes a screen displaying the virtual character of the current user account, equipped with the recommended virtual equipment according to the set options chosen by the current user account. Exemplarily, with continued reference to FIG. 4, after determining the recommended wearable equipment and shooting equipment for the current user account, the client may display a screen in the third region showing the virtual character of the current user account wearing the wearable equipment and holding the shooting equipment.

Operation 710: Display, in response to an acquisition operation on first virtual equipment of the recommended virtual equipment, an acquisition of the first virtual equipment and set an appearance of the first virtual equipment according to the skin style.

The first virtual equipment includes at least one of the wearable equipment or the shooting equipment. That is, when the current user account acquires the wearable equipment and shooting equipment corresponding to the set options, the client may automatically set the appearance of the wearable equipment according to the first skin style and/or set the appearance of the shooting equipment according to the second skin style, i.e., applying the skin styles to the wearable equipment and shooting equipment. The current user account can acquire other virtual equipment recommended to the current user account by the client.

In some embodiments, the client provides the function to acquire all recommended virtual equipment in the set recommendation interface. Alternatively, the client sequentially displays acquisition interfaces for different types of virtual equipment according to the types of a plurality of recommended virtual equipment, and provides the function to acquire the corresponding virtual equipment in the acquisition interface. For example, when the current user account acquires the recommended virtual equipment, the client first displays the first acquisition interface, which includes the recommended wearable equipment. In response to the acquisition operation on first wearable equipment, the client displays an acquisition of the first wearable equipment and sets an appearance of the first wearable equipment according to the skin style. The first wearable equipment refers to part or all of the wearable equipment included in the first acquisition interface, which is selected through the selection operation on the wearable equipment in the first acquisition interface.

After the acquisition of the first wearable equipment is completed, the client displays the second acquisition interface, which includes the recommended shooting equipment. In response to the acquisition operation on first shooting equipment, the client displays an acquisition of the first shooting equipment and sets an appearance of the first shooting equipment according to the skin style. The first shooting equipment refers to part or all of the shooting equipment included in the second acquisition interface, which is selected through the selection operation on the shooting equipment in the second acquisition interface. The first wearable equipment includes wearable equipment configured to accommodate the first shooting equipment. Exemplarily, the first wearable equipment includes a virtual backpack, and the first shooting equipment is stored in the virtual backpack.

In an embodiment, for the acquisition of recommended wearable equipment, there are a plurality of wearable types, with equipment belonging to different wearable types worn on different parts of the virtual character. In one example, the first wearable equipment acquired on the first acquisition interface includes the first equipment belonging to the first wearable type and the second equipment belonging to the second wearable type.

The wearable equipment in the first acquisition interface belongs to a first wearable type. In response to the acquisition operation of the first equipment, an acquisition of the first equipment is displayed, and an appearance of the first equipment is set according to the skin style.

Subsequently, the client updates the first acquisition interface, where the wearable equipment in the updated first acquisition interface belongs to the second wearable type, that is, after the acquisition of the first equipment of the first wearable type, the acquisition interface for the equipment of the second wearable type is displayed. In response to the acquisition operation of the second equipment, an acquisition of the second equipment is displayed, and an appearance of the second equipment is set according to the skin style.

The equipment of the first wearable type is worn on a first part of a virtual character, and the equipment of the second wearable type is worn on a second part of the virtual character, the first part being different from the second part. The first part and the second part are any two of the head, body, hands, legs, or feet.

In another embodiment, the client can display a third acquisition interface, which includes consumable equipment. Consumable equipment is either used by the virtual character of the current user account or is matched with the shooting equipment. In response to the acquisition operation on the consumable equipment in the fifth acquisition interface, an acquisition of the consumable equipment is displayed.

The order of the acquisition interfaces displayed by the client can be adjusted, which is not limited to the embodiments of the present disclosure.

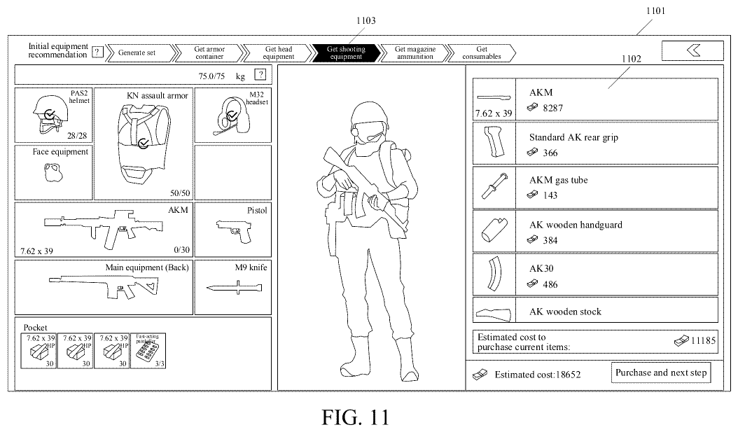

Exemplarily, FIG. 11 is a schematic diagram of a second acquisition interface according to an exemplary embodiment of the present disclosure. As shown in FIG. 11, the client displays the second acquisition interface 1101, where the second acquisition interface 1101 is the set recommendation interface with the second area replaced by a shooting equipment acquisition area 1102. The shooting equipment acquisition area 1102 displays the main equipment and part equipment recommended to the current user account, such as the virtual rifle body, rear grip, gas block, wood handguard, and stock. The current user account can purchase virtual equipment in the shooting equipment acquisition area 1102 as required. The second acquisition interface 1101 further includes an interface label control 1103. When the current user interface is the second acquisition interface 1101, the “acquire shooting equipment” label in the interface label control 1103 is highlighted to indicate the virtual equipment available for acquisition in the current user interface.

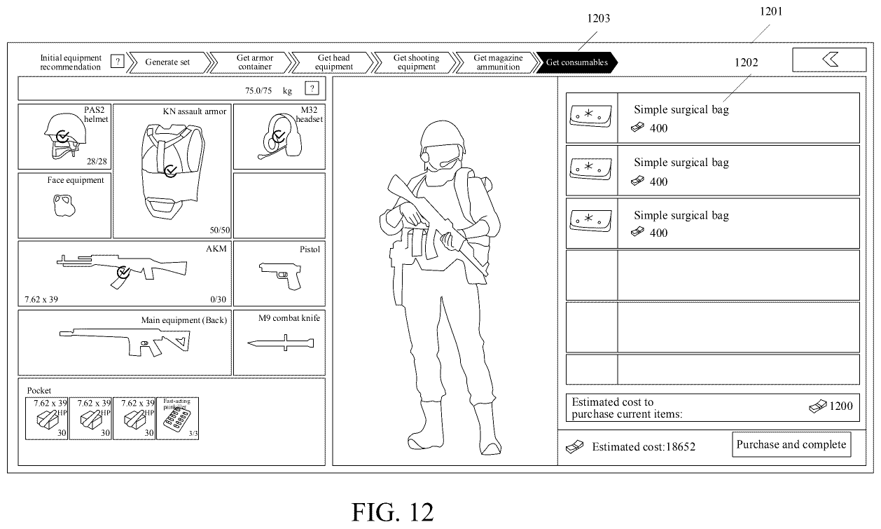

Exemplarily, FIG. 12 is a schematic diagram of a sixth acquisition interface according to an exemplary embodiment of the present disclosure. As shown in FIG. 12, the client displays the sixth acquisition interface 1201, where the sixth acquisition interface 1201 is the set recommendation interface with the second area replaced by a consumable equipment acquisition area 1202. The consumable equipment acquisition area 1202 displays the second consumable equipment recommended to the current user account, such as virtual surgical bags, virtual medical kits, and virtual painkillers. The current user account can acquire virtual equipment in the consumable equipment acquisition area 1202 as required. The sixth acquisition interface 1201 further includes an interface label control 1203. When the current user interface is the sixth acquisition interface 1201, the “acquire consumables” label in the interface label control 1203 is highlighted to indicate the virtual equipment available for acquisition in the current user interface.

In some embodiments, in response to the acquisition operation on the first virtual equipment, the client may automatically equip the first virtual equipment acquired by the current user account to the virtual character of the current user account. For example, the virtual character wears the acquired virtual armor and equips the acquired shooting equipment.

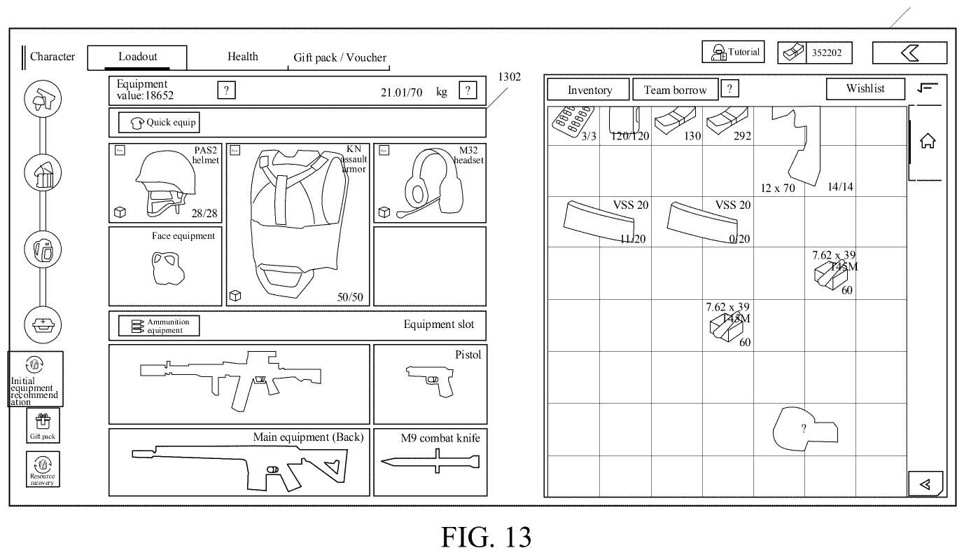

Exemplarily, FIG. 13 is a schematic diagram of a loadout interface according to an exemplary embodiment of the present disclosure. As shown in FIG. 13, the loadout interface 1301 is configured to manage the virtual equipment of the current user account. The equipped area 1302 in the loadout interface 1301 displays the virtual equipment that has been equipped to the virtual character. After the current user account acquires the first virtual equipment, the client may display the first virtual equipment in the equipped area 1302, indicating that the first virtual equipment has been equipped to the virtual character.

After acquiring and equipping the recommended complete set of virtual equipment for the virtual character, the current user account can replace part virtual equipment in the complete set of virtual equipment (virtual equipment corresponding to the same skin style) with other virtual equipment already owned. This allows the user to customize the set according to their preferences, and the customized set can be saved for easy switching and usage. For example, the current virtual character has acquired the virtual chest armor and virtual helmet from the blue set and has equipped them. The current user account can replace the equipped virtual helmet from the blue set with another owned virtual helmet in a different skin style, thereby creating and saving a customized set for personal use. Furthermore, the current user account can share the above customized set with other user accounts. The above solution can further meet the individual needs of the user.

In a user interface for displaying virtual equipment, such as a user interface for managing the virtual equipment owned by the current user account, the client can display virtual equipment according to the types of virtual equipment under different sets (skin styles). For example, the virtual chest armor, virtual backpack, and virtual ammunition pouch included in the blue set are displayed. In some embodiments, the virtual equipment may correspond to a virtual manufacturer (brand). In the user interface, the client can display the virtual equipment produced by different virtual manufacturers according to the virtual manufacturer, for example, displaying the virtual helmet and virtual chest armor produced by manufacturer 1. The above solution enables virtual equipment to be displayed according to the user's needs, facilitating the user's quick understanding of the virtual equipment from different perspectives. In some embodiments, before the virtual character of the current user account participates in a match, the client may recommend a virtual equipment set to the current user account. The skin style of the virtual equipment in the virtual equipment set matches the virtual environment of the match in which the virtual character is about to participate. For example, the skin style of the virtual equipment in the virtual equipment set is consistent with the color style of the match's virtual environment, facilitating the concealment of the virtual character within the virtual environment of the match. For example, if the virtual environment is a jungle, the client may recommend, before the match, a virtual equipment set with a camouflage skin style, including a virtual helmet, virtual armor, and virtual shooting equipment in the camouflage skin style.

In summary, according to the method provided in this embodiment, by displaying a set recommendation interface and recommending a complete set of wearable equipment and shooting equipment according to the user's selection of a set option, the user can, by simply selecting a set option, obtain a system-recommended complete set of virtual equipment with a skin style corresponding to the set option. Moreover, when the user acquires the recommended virtual equipment, the system automatically sets the appearance of the virtual equipment according to the skin style selected by the user, without requiring any additional settings from the user. In cases that the user loses virtual equipment due to the virtual character's death and needs to frequently acquire virtual equipment and set the appearance of the virtual equipment, the efficiency of configuring a complete set of skinned virtual equipment for the virtual character can be enhanced.

The method provided in this embodiment further provides set options separately for wearable equipment and shooting equipment, allowing the user to select skin styles for wearable equipment and shooting equipment, thereby better meeting the user's personalized needs and enhancing the flexibility of recommending virtual equipment.

The method provided in this embodiment further recommends body wearable equipment and head wearable equipment to the user when recommending wearable equipment, thereby achieving a more comprehensive recommendation of wearable equipment to the user. The method provided in this embodiment further recommends main equipment and part equipment to the user when recommending shooting equipment, thereby achieving a more comprehensive recommendation of shooting equipment to the user.

The method provided in this embodiment further applies skins, according to the user's habit of setting skins for the components of shooting equipment, to the recommended shooting equipment according to the selected set option. This enables the recommendation of shooting equipment that aligns with the user's habits, thereby enhancing the user experience. The method provided in this embodiment further recommends, based on the user's frequently used part equipment, shooting equipment to the user that includes the part equipment and meets the selected set option. This allows the recommendation of shooting equipment to the user while retaining the user's frequently used part equipment, thereby conforming to the user's usage habits and enhancing the user experience.

The method provided in this embodiment further generates shooting equipment recommended to the user according to the main equipment and part equipment from shooting equipment leaderboards, thereby enabling the recommendation of combination solutions with better performance to the user.

The method provided in this embodiment further provides the user with set options according to the skin styles of wearable equipment and shooting equipment used by relevant users, thereby enabling the user to quickly acquire virtual equipment that matches the equipment of the relevant users.

The method provided in this embodiment further provides the user with acquisition functions (e.g., purchase functions) for different types of virtual equipment sequentially through different acquisition interfaces, thereby guiding the user through the process of acquiring a complete set of virtual equipment and ensuring the integrity of the acquired virtual equipment of the user. The method provided in this embodiment further recommends virtual equipment to the user according to the user's selected budget or recommendation preferences, thereby enabling virtual equipment recommendations according to the user's requirements beyond skin styles and enhancing the user experience.

The method provided in this embodiment further displays preview information, allowing the user to preview the effect of the recommended virtual equipment before acquisition, thereby enhancing the user experience.

The method provided in this embodiment further automatically equips the acquired virtual equipment on the virtual character when the user acquires the recommended virtual equipment, without requiring the user to perform additional equipping operations, thereby enhancing the efficiency of equipping virtual equipment. The virtual equipment recommendation method provided by the present disclosure enhances the user's efficiency in configuring a complete set of skinned virtual equipment for the virtual character. The following describes the solutions provided in the present disclosure in the context of a shooting game. First, the basic settings of the shooting game are described.

Equipment system based on materialized parts: The shooting game in the embodiments of the present disclosure includes an equipment system based on materialized parts, which exhibits the following features: 1. Similar to the real world, each piece of virtual equipment is a concrete instance. 2. Each piece of virtual equipment occupies its own volume and has a degree of wear, just like real-world equipment.

Virtual equipment skins and sets: 1. Each piece of virtual equipment can be individually customized with a skin style, which affects only that specific piece of equipment and does not affect other virtual equipment of the same model in the inventory (the user may simultaneously own a plurality of virtual equipment of the same model). 2. The skin of virtual equipment of a model can be applied by the user to instances of virtual equipment of sub-models. 3. Virtual equipment skins exhibit set-based characteristics. That is, once general equipment (e.g., shooting equipment) is applied with a designated set skin, it forms a “set” concept. The virtual equipment included in the set has identical combat performance to the general equipment, with the only difference being that the set equipment features a unified, designed appearance style.

Shooting equipment system based on materialized parts: Unlike other shooting games in which shooting equipment is presented as an integral whole, a shooting game featuring a shooting equipment system based on materialized parts exhibits the following characteristics: 1. Similar to the real world, the shooting equipment has a storage volume. 2. Similar to the real world, each part is a distinct tangible part, and each piece of shooting equipment includes independent materialized parts. 3. The parts constituting specific shooting equipment are consumed during use, and the user can store a plurality of identical parts for replacement purposes.

The officials of the shooting game select some of the general equipment (e.g., wearable equipment) and create corresponding sets of skins. For example, the concept of the “blue set” in FIG. 3 includes two pieces of general equipment, a helmet and an assault armor, together with the blue set skins applied thereto. In the shooting game, this is defined as a set. The concept of shooting equipment (the complete gun) is similar to that of a set. The game officials select specific combinations from the components of shooting equipment to form a complete piece of shooting equipment and assign a full set of skins. This shooting equipment thus constitutes a complete piece of shooting equipment (the entire gun), for example, the “golden gun skin” rifle concept shown in FIG. 4.

Referring to FIG. 3 and FIG. 4, the set recommendation interface in the embodiments of the present disclosure is described.

1. Generate equipment preview area: The details of the generated solution are displayed here. 2. Visual preview area: After the solution is generated, a visual preview applied to the external appearance is displayed here. 3. Set configuration selection area: This area includes wearable set configurations and shooting set configurations. Once a selection is made, the remaining components are intelligently recommended based on these two components. 4. Recommended plan detail setting area: This area sets the price range and recommendation style for intelligent recommendations. 5. Generate button: Tapping this button generates a recommended plan, and tapping it again randomly refreshes the generated plan.

Referring to FIG. 3 and FIG. 4, the set recommendation and acquisition process in the embodiments of the present disclosure are described.

1. When the user's virtual character is not equipped with any virtual equipment, tapping the “initial equipment recommendation” button shown in FIG. 6 initiates the recommendation system. 2. The user enters the recommendation system, where the set recommendation interface is displayed. 3. After selecting the blue set and the golden gun skin, the user generates a set costing less than 27,600 coins. 4. The user proceeds with the acquisition. After acquiring the wearable equipment, the user acquires and assembles the shooting equipment while simultaneously applying the skins. 5. After completing the acquisition of the set, the user proceeds to acquire other consumable equipment.

The user's entire acquiring process is divided into five sequential parts: (1) First, the user acquires and equips armor and containers, where the user acquires the basic set equipment, applies the skins, and equips them on the virtual character. (2) Next, the user acquires head equipment, where part of the set is acquired, has the skins applied, and is equipped on the virtual character. (3) The user acquires the main equipment and the required part equipment, assembles them into complete shooting equipment, and simultaneously equips it on the virtual character. (4) The user acquires the ammunition and magazines needed for the shooting equipment. (5) Finally, the user acquires consumable equipment for the virtual character.

6. After completing the acquires, the user closes the system. All selected virtual equipment has been acquired with the corresponding skins applied and has been equipped on the virtual character in the appropriate positions.

The process of recommending virtual equipment to the user according to the user-selected plan can be divided into the following operations:

1. Acquire the item contents of the virtual equipment included in the user-selected skin sets, including shooting equipment skin sets and wearable equipment skin sets. 2. Based on the item contents, determine the total budget value for recommending virtual equipment using a value algorithm. 3. According to the value range, select from the equipment repository a piece of shooting equipment that meets the budget and corresponds to the user-selected skin set, and filter the combinations that match the user-selected skin set to serve as the final recommended content. 4. According to the determined shooting equipment, randomly select a combination of bullets within the value range from the bullets that can be equipped on the shooting equipment. 5. According to the value range, randomly select a combination of armor, containers, and ammunition pouches to be equipped on the virtual character, and filter the combinations that match the user-selected skin set to serve as the final recommended content. 6. According to the value range, randomly select a combination of helmets, masks, and headsets to be equipped on the virtual character's head, and filter the combinations that match the user-selected skin set to serve as the final recommended content. 7. According to the value range, randomly select a combination of items, such as medicines and food, to be stored in the virtual character's pockets and containers. 8. When price fluctuations occur in the in-game auction house and the system cannot randomly select virtual equipment within the value range in the previous five operations, the system selects virtual equipment for the user at price points close to the user's budget, ensuring that a usable recommended set of virtual equipment is available without significantly exceeding the user's budget.

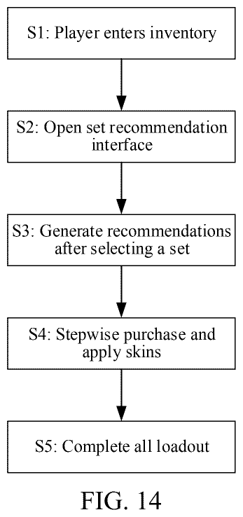

Exemplarily, FIG. 14 is a schematic flow diagram of recommending and acquiring virtual equipment according to an exemplary embodiment of the present disclosure. As shown in FIG. 14, in operation S1, the player enters the inventory interface for managing virtual equipment. In operation S2, the player opens the set recommendation interface. In operation S3, after the player selects a system-recommended set, the complete set of recommended virtual equipment is generated. In operation S4, the player stepwise acquires the recommended virtual equipment, and the system automatically applies the skins according to the solution. In operation S5, the player acquires consumable equipment, and the system automatically performs a loadout.

The method provided in the embodiments of the present disclosure allows the user to simply select a set in combination with intelligent recommendations, visually presenting the effect of wearing the recommended virtual equipment. Using the subsequent acquiring function, the user can quickly complete the acquisition and assembly of wearable equipment and shooting equipment, which is then automatically equipped on the virtual character. Moreover, the user can acquire consumable equipment corresponding to the wearable equipment and shooting equipment, thereby replenishing the required consumables. The user can use a simple selection method, similar to ordering dishes, to complete complex operations, such as acquiring, replenishing, applying skins, and equipping, in a single set of straightforward operations, thereby allowing the user to conveniently and efficiently organize their equipment and enhancing the efficiency of configuring a complete set of skinned virtual equipment for the virtual character.

In the present disclosure, before and during the collection of the user's relevant data (for example, frequently used shooting equipment and frequently used part equipment in the present disclosure), a prompt interface and pop-up may be displayed, or voice prompt information may be outputted to notify the user that their relevant data is being collected. The present disclosure only proceeds with the relevant operations for acquiring the user's relevant data after receiving a confirmation action from the user on the prompt interface or pop-up. Otherwise, if no confirmation action from the user on the prompt interface or pop-up is received, the relevant operations for acquiring the user's relevant data are terminated, and the user's relevant data is not collected. In other words, all user data collected in the present disclosure is obtained only with the user's consent and authorization, and the collection, use, and processing of such data shall comply with the applicable laws, regulations, and standards of the relevant countries and regions.

The order of the method operations provided in the embodiments of the present disclosure may be appropriately adjusted, and operations may be added, omitted, or modified as appropriate. Any variations of the methods that can be readily conceived by a person skilled in the art within the scope of the disclosure of the present disclosure are intended to be encompassed within the scope of protection of the present disclosure and, therefore, are not described in detail herein.

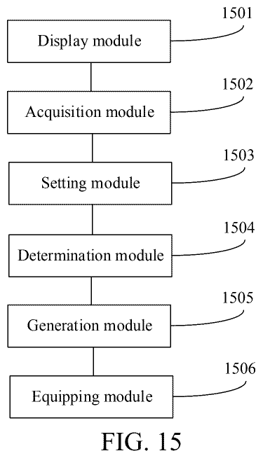

FIG. 15 is a schematic structural diagram of a virtual equipment recommendation apparatus according to an exemplary embodiment of the present disclosure. As shown in FIG. 15, the apparatus includes:
a display module 1501, configured to perform operation 502 in the embodiment of FIG. 5, the set recommendation interface including a first area, and the first area including at least one set option;
the display module 1501, further configured to perform operation 504 in the embodiment of FIG. 5, the recommended virtual equipment including at least wearable equipment and shooting equipment, and appearances of the wearable equipment and the shooting equipment displayed in the second area having a skin style corresponding to the first set option; and

the display module 1501, further configured to perform operation 506 in the embodiment of FIG. 5, the first virtual equipment including at least one of the wearable equipment or the shooting equipment.

In an exemplary embodiment, the first area includes a first sub-area and a second sub-area, the first sub-area including at least one wearable set option, and the second sub-area including at least one shooting set option. The display module 1501 is configured to perform operation 704 and operation 706 in the embodiment of FIG. 7, where the appearance of the wearable equipment has a first skin style corresponding to the first wearable set option, and the appearance of the shooting equipment has a second skin style corresponding to the second shooting set option.

In an exemplary embodiment, the display module 1501 is configured to display at least one of body wearable equipment or head wearable equipment corresponding to the first wearable set option in the second area, an appearance of all or part of the virtual equipment corresponding to the first wearable set option displayed in the second area having the first skin style.

In an exemplary embodiment, the display module 1501 is configured to display at least one of main equipment or part equipment corresponding to the first shooting set option in the second area, the main equipment and the part equipment being components of the shooting equipment, and appearance of all or part of the virtual equipment corresponding to the first shooting set option displayed in the second area having the second skin style.

In an exemplary embodiment, the display module 1501 is configured to visually highlight, in response to the selection operation on the first wearable set option, a recommended shooting set option of the at least one shooting set option.

Recommended shooting equipment corresponding to the recommended shooting set option shares at least one of a texture, material, or bonus effect with the wearable equipment corresponding to the first wearable set option.

In an exemplary embodiment, the display module 1501 is configured to apply skins to the wearable equipment and shooting equipment in the default appearance according to the skin color and shading mode corresponding to the skin style to obtain the wearable equipment and shooting equipment displayed in the second area.

In an exemplary embodiment, the shooting equipment in the shooting game includes main equipment and part equipment, and the apparatus further includes:
an acquisition module 1502, configured to acquire appearance setting habits of frequently used main equipment and frequently used part equipment of the current user account, the appearance setting habits being configured for reflecting the equipment with appearance settings in the frequently used main equipment and frequently used part equipment; and
a setting module 1503, configured to set, based on the skin style and according to the appearance setting habits, appearances of the main equipment and part equipment of the shooting equipment in the recommended virtual equipment, to obtain the shooting equipment displayed in the second area.

In an exemplary embodiment, the shooting equipment in the shooting game includes main equipment and part equipment, and the apparatus further includes:
the acquisition module 1502, configured to acquire, from the frequently used part equipment of the current user account, matching part equipment that supports setting an appearance according to the skin style;
a determination module 1504, configured to determine a plurality pieces of main equipment that match the matching part equipment;
the determination module 1504, further configured to determine, from the plurality pieces of main equipment, matching main equipment that supports setting an appearance according to the skin style; and
a generation module 1505, configured to generate, according to the matching part equipment and the matching main equipment, the shooting equipment in the recommended virtual equipment.

In an exemplary embodiment, the shooting equipment in the shooting game includes main equipment and part equipment, and the apparatus further includes:
the acquisition module 1502, configured to acquire at least one leaderboard of a first leaderboard, a second leaderboard, a third leaderboard, a fourth leaderboard, or a fifth leaderboard; and
a generation module 1505, configured to generate, according to main equipment and part equipment of the top n shooting equipment in the at least one leaderboard, the shooting equipment in the recommended virtual equipment.

The first leaderboard is configured to rank different shooting equipment according to shooting accuracy, the second leaderboard is configured to rank the different shooting equipment according to shooting damage, the third leaderboard is configured to rank the different shooting equipment according to the number of uses, the fourth leaderboard is configured to rank the different shooting equipment according to win rate, and the fifth leaderboard is configured to rank the different shooting equipment according to points of corresponding user accounts, the different shooting equipment including at least one of shooting equipment of friend user accounts, shooting equipment of same-team user accounts, and shooting equipment of same-server user accounts of the current user account, and n being a positive integer.

In an exemplary embodiment, the apparatus further includes:
the determination module 1504, configured to determine, according to the skin style of the appearance of the wearable equipment and shooting equipment of the relevant user account of the current user account, the skin style corresponding to the set option, the relevant user account including at least one of a friend user account of the current user account, a user account frequently teamed with the current user account, a lover user account of the current user account, and a user account followed by the current user account.

In an exemplary embodiment, the display module 1501 is configured to:
display a first acquisition interface, the first acquisition interface including the wearable equipment; display, in response to an acquisition operation on first wearable equipment, an acquisition of the first wearable equipment and set an appearance of the first wearable equipment according to the skin style;
display a second acquisition interface, the second acquisition interface including the shooting equipment; and display, in response to an acquisition operation on first shooting equipment, an acquisition of the first shooting equipment and set an appearance of the first shooting equipment according to the skin style.

The first wearable equipment includes wearable equipment configured to accommodate the first shooting equipment.

In an exemplary embodiment, the display module 1501 is configured to:

display, in response to an acquisition operation on the first equipment, an acquisition of the first equipment and set an appearance of the first equipment according to the skin style;
update the first acquisition interface, the wearable equipment in the updated first acquisition interface belonging to the second wearable type; and
display, in response to an acquisition operation on the second equipment, an acquisition of the second equipment and set an appearance of the second equipment according to the skin style.

The equipment of the first wearable type is worn on a first part of a virtual character, and the equipment of the second wearable type is worn on a second part of the virtual character, the first part being different from the second part.

In an exemplary embodiment, the recommended virtual equipment further includes first consumable equipment used by a virtual character of the current user account or first consumable equipment matching the shooting equipment, and the display module 1501 is configured to:
display a third acquisition interface; and display, in response to an acquisition operation on the consumable equipment in the third acquisition interface, an acquisition of the consumable equipment.

In an exemplary embodiment, the set recommendation interface further includes a budget setting control, and the apparatus further includes:
the acquisition module 1502, configured to acquire, in response to a budget setting operation on the budget setting control, an equipment recommendation budget.

The recommended virtual equipment displayed in the second area is recommended based on the equipment recommendation budget.

In an exemplary embodiment, the set recommendation interface further includes a recommendation preference setting control. As shown in FIG. 20, the apparatus further includes:
the acquisition module 1502, configured to acquire, in response to a recommendation preference setting operation on the recommendation preference setting control, equipment recommendation preference information, the type of recommended virtual equipment displayed in the second area being recommended based on the equipment recommendation preference information.

In an exemplary embodiment, the set recommendation interface further includes a third area, and the display module 1501 is configured to:
display preview information in the third area, the preview information including the visual in which the virtual character of the current user account equips the recommended virtual equipment.

In an exemplary embodiment, the apparatus further includes:
an equipping module 1506, configured to equip, in response to an acquisition operation on the first virtual equipment, the first virtual equipment to a virtual character of the current user account.

The virtual equipment recommendation apparatus provided in the above embodiments is described merely by way of illustration based on the division of the functional modules. The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. In actual applications, the functions may be assigned to different functional modules as needed, that is, the internal structure of the device may be divided into different functional modules to implement all or part of the functions described above. In addition, the virtual equipment recommendation apparatus provided in the above embodiments and the embodiments of the virtual equipment recommendation method are based on the same concept. The specific implementation process is described in detail in the method embodiments and is not repeated herein.

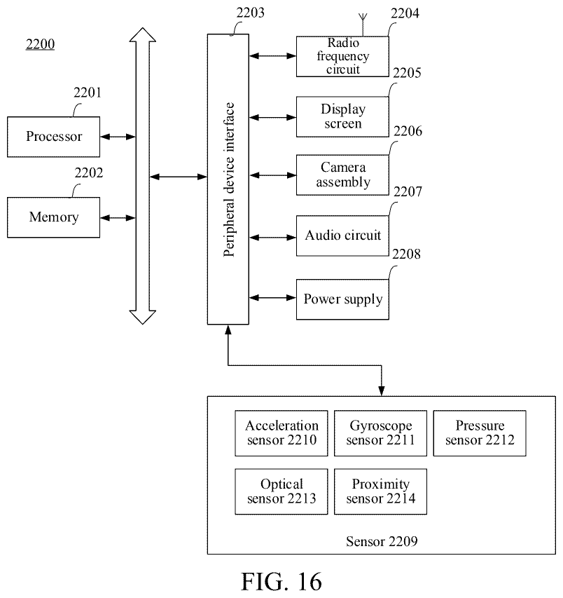

The embodiments of the present disclosure further provide a computer device including a processor and a memory having at least one instruction, at least one program, a code set, or an instruction set stored therein, the at least one instruction, the at least one program, the code set, or the instruction set being loaded and executed by the processor to implement the virtual equipment recommendation method provided in the above method embodiments. Exemplarily, FIG. 16 is a schematic structural diagram of a terminal according to an exemplary embodiment of the present disclosure.

Generally, the terminal 2200 includes a processor 2201 and a memory 2202.

The processor 2201 may include one or more processing cores, such as a quad-core processor or an octa-core processor. The processor 2201 may be implemented in at least one hardware form, such as a digital signal processor (DSP), a field-programmable gate array (FPGA), or a programmable logic array (PLA). The processor 2201 may further include a main processor and a co-processor. The main processor is configured to process data in an active (wake) state and is also referred to as a central processing unit (CPU). The co-processor is a low-power processor configured to process data in a standby state. In some embodiments, the processor 2201 may be integrated with a graphics processing unit (GPU), which is configured to render and draw content to be displayed on the display screen. In some embodiments, the processor 2201 may further include an artificial intelligence (AI) processor, which is configured to perform computational operations related to machine learning. The memory 2202 may include one or more computer-readable storage media, which may be non-transitory. The memory 2202 may further include a high-speed random-access memory and a non-volatile memory, such as one or more disk storage devices or flash storage devices. In some embodiments, the non-transitory computer-readable storage medium in the memory 2202 is configured to store at least one instruction, the at least one instruction being executable by the processor 2201 to implement the virtual equipment recommendation method provided in the method embodiments of the present disclosure.

In some embodiments, the terminal 2200 may further include a peripheral device interface 2203 and at least one peripheral device. The processor 2201, the memory 2202, and the peripheral device interface 2203 may be connected via a bus or signal line. Each peripheral device may be connected to the peripheral device interface 2203 via a bus, a signal line, or a circuit board. In particular, the peripheral devices include at least one of a radio frequency (RF) circuit 2204, a display screen 2205, a camera assembly 2206, an audio circuit 2207, and a power supply 2208. The peripheral device interface 2203 may be configured to connect at least one I/O-related peripheral device to the processor 2201 and the memory 2202. In some embodiments, the processor 2201, the memory 2202, and the peripheral device interface 2203 are integrated on the same chip or circuit board. In other embodiments, any one or two of the processor 2201, the memory 2202, and the peripheral device interface 2203 may be implemented on separate chips or circuit boards, which is not limited to the embodiments of the present disclosure. The RF circuit 2204 is configured to receive and transmit RF signals, which are also referred to as electromagnetic signals. The RF circuit 2204 communicates with a communication network and other communication devices via electromagnetic signals. The display screen 2205 is configured to display the UI. The UI may include graphics, text, icons, video, or any combination thereof. The camera assembly 2206 is configured to capture images or video. In some embodiments, the camera assembly 2206 may include a front-facing camera and a rear-facing camera. The audio circuitry 2207 may include a microphone and a speaker. The microphone is configured to capture sound waves from the user and the environment, and convert the sound waves into electrical signals for input to the processor 2201 for processing, or to the RF circuit 2204 to achieve voice communication. The power supply 2208 is configured to supply power to the various assemblies of the terminal 2200. The power supply 2208 may be an alternating current (AC) source, a direct current (DC) source, a primary battery, or a rechargeable battery. In some embodiments, the terminal 2200 further includes one or more sensors 2209. The one or more sensors 2209 include, but are not limited to, an acceleration sensor 2210, a gyroscope sensor 2211, a pressure sensor 2212, an optical sensor 2213, and a proximity sensor 2214. The acceleration sensor 2210 is configured to detect the magnitude of acceleration along the three axes of the coordinate system established by the terminal 2200. The gyroscope sensor 2211 is configured to detect the orientation and rotation angle of the terminal 2200. The gyroscope sensor 2211 may operate in conjunction with the acceleration sensor 2210 to capture the user's 3D movements of the terminal 2200. The pressure sensor 2212 may be disposed on the side frame of the terminal 2200 and/or beneath a touch display screen 2205. The pressure sensor is configured to detect the user's grip signal on the terminal 2200 and/or, according to the pressure applied by the user on the touch display screen 2205, control operable controls on the UI. The optical sensor 2213 is configured to collect the ambient light intensity. The proximity sensor 2214, also referred to as a distance sensor, is typically disposed on the front panel of the terminal 2200. The proximity sensor 2214 is configured to detect the distance between the user and the front surface of the terminal 2200.

A person skilled in the art may understand that the structure shown in FIG. 16 does not limit the terminal 2200. The terminal may include more or fewer assemblies than those illustrated, some assemblies may be combined, or different assembly arrangements may be employed.

The embodiments of the present disclosure further provide a computer-readable storage medium having at least one instruction, at least one program, a code set, or an instruction set stored therein, the at least one instruction, at least one program, code set, or instruction set, when loaded and executed by a processor of a computer device, implementing the virtual equipment recommendation method provided in the above method embodiments.

The present disclosure further provides a computer program product or a computer program, the computer program product or the computer program including computer instructions. The computer instructions are stored in a computer-readable storage medium. A processor of a computer device reads the computer instructions from the computer-readable storage medium and executes the computer instructions to cause the computer device to perform the virtual equipment recommendation method provided in the above method embodiments.

A person of ordinary skill in the art may understand that all or part of the operations of the above embodiments may be implemented by hardware, or may be implemented by a program instructing relevant hardware. The program may be stored in a computer-readable storage medium. The readable storage medium described above may be a read-only memory, a magnetic disk, an optical disc, or the like.

What is claimed is:

1. A virtual equipment recommendation method, executed by a terminal, the method comprising:
displaying a set recommendation interface in a shooting game, the set recommendation interface comprising a first area, and the first area comprising at least one set option;
displaying, in response to a selection operation on a first set option of the at least one set option, recommended virtual equipment corresponding to the first set option in a second area of the set recommendation interface, the recommended virtual equipment comprising at least wearable equipment and shooting equipment, and appearances of the wearable equipment and the shooting equipment displayed in the second area having a skin style corresponding to the first set option; and
displaying, in response to an acquisition operation on first virtual equipment of the recommended virtual equipment, an acquisition of the first virtual equipment and setting an appearance of the first virtual equipment according to the skin style, the first virtual equipment comprising at least one of the wearable equipment or the shooting equipment.

2. The method according to claim 1, wherein the first area comprises a first sub-area and a second sub-area, the first sub-area comprising at least one wearable set option, and the second sub-area comprising at least one shooting set option; and
the displaying, in response to a selection operation on a first set option of the at least one set option, recommended virtual equipment corresponding to the first set option in a second area of the set recommendation interface comprises:
displaying, in response to a selection operation on a first wearable set option of the at least one wearable set option, wearable equipment corresponding to the first wearable set option in the second area, an appearance of the wearable equipment having a first skin style corresponding to the first wearable set option; and
displaying, in response to a selection operation on a first shooting set option of the at least one shooting set option, shooting equipment corresponding to the first shooting set option in the second area, an appearance of the shooting equipment having a second skin style corresponding to the first shooting set option.

3. The method according to claim 2, wherein the displaying wearable equipment corresponding to the first wearable set option in the second area comprises:
displaying at least one of body wearable equipment or head wearable equipment corresponding to the first wearable set option in the second area,
appearance of all or part of the virtual equipment corresponding to the first wearable set option displayed in the second area having the first skin style.

4. The method according to claim 2, wherein the displaying shooting equipment corresponding to the first shooting set option in the second area comprises:
displaying at least one of main equipment or part equipment corresponding to the first shooting set option in the second area,
the main equipment and the part equipment being components of the shooting equipment, and appearance of all or part of the virtual equipment corresponding to the first shooting set option displayed in the second area having the second skin style.

5. The method according to claim 2, further comprising:
visually highlighting, in response to the selection operation on the first wearable set option, a recommended shooting set option of the at least one shooting set option,
recommended shooting equipment corresponding to the recommended shooting set option sharing at least one of a texture, material, or bonus effect with the wearable equipment corresponding to the first wearable set option.

6. The method according to claim 1, wherein the shooting equipment in the shooting game comprises main equipment and part equipment, and the method further comprises:
acquiring appearance setting habits of frequently used main equipment and frequently used part equipment of the current user account, the appearance setting habits reflecting equipment with appearance settings in the frequently used main equipment and frequently used part equipment; and
setting, based on the skin style and according to the appearance setting habits, appearances of the main equipment and part equipment of the shooting equipment in the recommended virtual equipment, to obtain the shooting equipment displayed in the second area.

7. The method according to claim 1, wherein the shooting equipment in the shooting game comprises main equipment and part equipment, and the method further comprises:
acquiring, from the frequently used part equipment of the current user account, matching part equipment that supports setting an appearance according to the skin style;
determining a plurality pieces of main equipment that match the matching part equipment;
determining, from the plurality pieces of main equipment, matching main equipment that supports setting an appearance according to the skin style; and
generating, according to the matching part equipment and the matching main equipment, the shooting equipment in the recommended virtual equipment.

8. The method according to claim 1, wherein the shooting equipment in the shooting game comprises main equipment and part equipment, and the method further comprises:
acquiring at least one leaderboard of a first leaderboard, a second leaderboard, a third leaderboard, a fourth leaderboard, or a fifth leaderboard; and
generating, according to main equipment and part equipment of the top n shooting equipment in the at least one leaderboard, the shooting equipment in the recommended virtual equipment, wherein
the first leaderboard is configured to rank different shooting equipment according to shooting accuracy, the second leaderboard is configured to rank the different shooting equipment according to shooting damage, the third leaderboard is configured to rank the different shooting equipment according to the number of uses, the fourth leaderboard is configured to rank the different shooting equipment according to win rate, and the fifth leaderboard is configured to rank the different shooting equipment according to points of corresponding user accounts, the different shooting equipment comprising at least one of shooting equipment of friend user accounts, shooting equipment of same-team user accounts, or shooting equipment of same-server user accounts of the current user account, and n being a positive integer.

9. The method according to claim 1, wherein the displaying, in response to an acquisition operation on first virtual equipment of the recommended virtual equipment, an acquisition of the first virtual equipment and setting an appearance of the first virtual equipment according to the skin style comprises:
displaying a first acquisition interface, the first acquisition interface comprising the wearable equipment;
displaying, in response to an acquisition operation on first wearable equipment, an acquisition of the first wearable equipment and setting an appearance of the first wearable equipment according to the skin style;
displaying a second acquisition interface, the second acquisition interface comprising the shooting equipment; and
displaying, in response to an acquisition operation on first shooting equipment, an acquisition of the first shooting equipment and setting an appearance of the first shooting equipment according to the skin style, wherein
the first wearable equipment comprises wearable equipment configured to accommodate the first shooting equipment.

10. The method according to claim 9, wherein the wearable equipment in the first acquisition interface belongs to a first wearable type, the first wearable equipment comprising first equipment belonging to the first wearable type and second equipment belonging to a second wearable type; and
the displaying, in response to an acquisition operation on first wearable equipment, an acquisition of the first wearable equipment and setting an appearance of the first wearable equipment according to the skin style comprises:
displaying, in response to an acquisition operation on the first equipment, an acquisition of the first equipment and setting an appearance of the first equipment according to the skin style;
updating the first acquisition interface, the wearable equipment in the updated first acquisition interface belonging to the second wearable type; and
displaying, in response to an acquisition operation on the second equipment, an acquisition of the second equipment and setting an appearance of the second equipment according to the skin style, wherein
the equipment of the first wearable type is worn on a first part of a virtual character, and the equipment of the second wearable type is worn on a second part of the virtual character, the first part being different from the second part.

11. The method according to claim 9, wherein the recommended virtual equipment further comprises consumable equipment used by a virtual character of the current user account or consumable equipment matching the shooting equipment; and the method further comprises:
displaying a third acquisition interface; and
displaying, in response to an acquisition operation on the consumable equipment in the third acquisition interface, an acquisition of the consumable equipment.

12. A virtual equipment recommendation apparatus, comprising:
a processor and a memory having at least one program stored therein, the at least one program being loaded and executed by the processor to implement:
displaying a set recommendation interface in a shooting game, the set recommendation interface comprising a first area, and the first area comprising at least one set option;
displaying, in response to a selection operation on a first set option of the at least one set option, recommended virtual equipment corresponding to the first set option in a second area of the set recommendation interface, the recommended virtual equipment comprising at least wearable equipment and shooting equipment, and appearances of the wearable equipment and the shooting equipment displayed in the second area having a skin style corresponding to the first set option; and
displaying, in response to an acquisition operation on first virtual equipment of the recommended virtual equipment, an acquisition of the first virtual equipment and setting an appearance of the first virtual equipment according to the skin style, the first virtual equipment comprising at least one of the wearable equipment or the shooting equipment.

13. The apparatus according to claim 12, wherein the first area comprises a first sub-area and a second sub-area, the first sub-area comprising at least one wearable set option, and the second sub-area comprising at least one shooting set option; and
the displaying, in response to a selection operation on a first set option of the at least one set option, recommended virtual equipment corresponding to the first set option in a second area of the set recommendation interface comprises:
displaying, in response to a selection operation on a first wearable set option of the at least one wearable set option, wearable equipment corresponding to the first wearable set option in the second area, an appearance of the wearable equipment having a first skin style corresponding to the first wearable set option; and
displaying, in response to a selection operation on a first shooting set option of the at least one shooting set option, shooting equipment corresponding to the first shooting set option in the second area, an appearance of the shooting equipment having a second skin style corresponding to the first shooting set option.

14. The apparatus according to claim 13, wherein the displaying wearable equipment corresponding to the first wearable set option in the second area comprises:
displaying at least one of body wearable equipment or head wearable equipment corresponding to the first wearable set option in the second area,
appearance of all or part of the virtual equipment corresponding to the first wearable set option displayed in the second area having the first skin style.

15. The apparatus according to claim 13, wherein the displaying shooting equipment corresponding to the first shooting set option in the second area comprises:
displaying at least one of main equipment or part equipment corresponding to the first shooting set option in the second area,
the main equipment and the part equipment being components of the shooting equipment, and appearance of all or part of the virtual equipment corresponding to the first shooting set option displayed in the second area having the second skin style.

16. The apparatus according to claim 13, wherein the processor is further configured to implement:
visually highlighting, in response to the selection operation on the first wearable set option, a recommended shooting set option of the at least one shooting set option,
recommended shooting equipment corresponding to the recommended shooting set option sharing at least one of a texture, material, or bonus effect with the wearable equipment corresponding to the first wearable set option.

17. The apparatus according to claim 12, wherein the shooting equipment in the shooting game comprises main equipment and part equipment, and the processor is further configured to implement:
acquiring appearance setting habits of frequently used main equipment and frequently used part equipment of the current user account, the appearance setting habits reflecting equipment with appearance settings in the frequently used main equipment and frequently used part equipment; and
setting, based on the skin style and according to the appearance setting habits, appearances of the main equipment and part equipment of the shooting equipment in the recommended virtual equipment, to obtain the shooting equipment displayed in the second area.

18. The apparatus according to claim 12, wherein the shooting equipment in the shooting game comprises main equipment and part equipment, and the processor is further configured to implement:
acquiring, from the frequently used part equipment of the current user account, matching part equipment that supports setting an appearance according to the skin style;
determining a plurality pieces of main equipment that match the matching part equipment;
determining, from the plurality pieces of main equipment, matching main equipment that supports setting an appearance according to the skin style; and
generating, according to the matching part equipment and the matching main equipment, the shooting equipment in the recommended virtual equipment.

19. The apparatus according to claim 12, wherein the displaying, in response to an acquisition operation on first virtual equipment of the recommended virtual equipment, an acquisition of the first virtual equipment and setting an appearance of the first virtual equipment according to the skin style comprises:
displaying a first acquisition interface, the first acquisition interface comprising the wearable equipment;
displaying, in response to an acquisition operation on first wearable equipment, an acquisition of the first wearable equipment and setting an appearance of the first wearable equipment according to the skin style;
displaying a second acquisition interface, the second acquisition interface comprising the shooting equipment; and
displaying, in response to an acquisition operation on first shooting equipment, an acquisition of the first shooting equipment and setting an appearance of the first shooting equipment according to the skin style, wherein
the first wearable equipment comprises wearable equipment configured to accommodate the first shooting equipment.

20. A non-transitory computer-readable storage medium having at least one program stored therein, the at least one program being loaded and executed by a processor to implement:
displaying a set recommendation interface in a shooting game, the set recommendation interface comprising a first area, and the first area comprising at least one set option;
displaying, in response to a selection operation on a first set option of the at least one set option, recommended virtual equipment corresponding to the first set option in a second area of the set recommendation interface, the recommended virtual equipment comprising at least wearable equipment and shooting equipment, and appearances of the wearable equipment and the shooting equipment displayed in the second area having a skin style corresponding to the first set option; and
displaying, in response to an acquisition operation on first virtual equipment of the recommended virtual equipment, an acquisition of the first virtual equipment and setting an appearance of the first virtual equipment according to the skin style, the first virtual equipment comprising at least one of the wearable equipment or the shooting equipment.
